(19) United States
(12) Patent Application Publication
(10) Pub. No.: US 2022/0125022 A1
(43) Pub. Date: Apr. 28, 2022

(54) UNIVERSAL ANIMAL RECORDS PLATFORM

(71) Applicant: PETRECORD, LLC, Frederick, MD (US)

(72) Inventor: Emma Elizabeth Adams, Frederick, MD (US)

(21) Appl. No.: 17/510,228

(22) Filed: Oct. 25, 2021

Related U.S. Application Data
(60) Provisional application No. 63/105,600, filed on Oct. 26, 2020.

(51) Int. Cl. A01K 29/00; H04L 29/08; G06F 21/62

(52) U.S. Cl. CPC A01K 29/005; G06F 21/6245; H04L 67/306

(57) ABSTRACT

The present teachings include processing animal records and providing access thereto for a variety of users having different permissions. The animal records are stored in an animal profile associated with a unique identifier provided by a wearable and/or implantable tag. The system provides universal access to portions of the animal profile based upon user permissions. A guardian profile associated with the animal profile stores guardian contact information, which may be hidden from some users. The system may automatically notify the guardian if a triggering event occurs, such as if a lost animal is reported found. The system simplifies sharing animal medical records and reuniting lost pets with owners, while protecting the privacy of animal guardians and sensitive animal records information.

### CROSS-REFERENCE TO RELATED APPLICATIONS

This application claims priority to U.S. Provisional App. No. 63/105,600 filed on Oct. 26, 2020, the entire content of which is hereby incorporated by reference.

### FIELD

The present disclosure generally relates to devices, systems, and methods related to animal records, e.g., processing and storing animal records and providing access thereto.

### BACKGROUND

Existing animal record systems (e.g., for pets and the like) often lack cohesiveness and accessibility. For example, there may be a disconnect between veterinarians, animal shelters, and pet owners. That is, while each practice typically holds its own records, there may be no means for an organization to access information that another organization possesses. For example, in the context of a veterinarian office, often times, files must be manually sent by an office employee after being requested by another entity, meaning workers at the veterinarian's office must scan, fax, and email documents multiple times a day for different clients. These same office workers may also be responsible for making calls and writing emails every time an animal's records are requested, e.g., by an emergency clinic, specialist, and/or rescue organization. Thus, hours of time and other resources each week may be wasted on such tasks, which can be highly detrimental and inefficient, especially on days when a clinic is busy or on days where an office must accommodate an emergency appointment or the like.

Moreover, and continuing the example of a veterinarian's office, clients may bring in stray animals that have no background of medical history. In situations like this, the office will handle the pet with extra caution since the workers cannot be sure if the animal is healthy and vaccinated—this is because, if a member of the staff is bitten, they could be infected by a disease that is transmissible to humans, such as rabies or leptospirosis.

While current microchip systems can generally do an adequate job reuniting lost pets with their owners, these systems may not provide access to veterinary history and the like. And, mostly, currently available veterinary record-keeping platforms are flawed and unreliable.

There remains a need for improved animal records systems and techniques.

### SUMMARY

The present teachings include processing animal records and providing access thereto for a variety of users having different permissions. The animal records are stored in an animal profile associated with a unique identifier provided by a wearable and/or implantable tag. The system provides universal access to portions of the animal profile based upon user permissions. A guardian profile associated with the animal profile stores guardian contact information, which may be hidden from some users. The system may automatically notify the guardian if a triggering event occurs, such as if a lost animal is reported found. The system simplifies sharing animal medical records and reuniting lost pets with owners, while protecting the privacy of animal guardians and sensitive animal records information.

In an aspect, a method for processing animal records disclosed herein may include: receiving, over a data network by a remote computing resource, a unique identifier associated with a tag, the tag scannable via a tag sensor to retrieve the unique identifier; creating, by the remote computing resource, an animal profile associated with the unique identifier; associating the animal profile with a guardian profile, the guardian profile including at least contact information for a guardian associated with an animal included in the animal profile; storing animal-specific information for the animal in the animal profile, the animal-specific information including at least one of a vaccination record, a medical procedure record, a current treatment, health history, a certification, a dietary restriction, animal breed information, and genetic information; and providing a user interface for accessing at least a portion of one or more of the animal profile and the guardian profile from the remote computing resource over the data network. Information within the user interface may be configured for access by each of: a first user associated with the guardian profile, the first user having permission to edit the guardian profile and at least a portion of the animal profile and permission to view all of the animal-specific information in the animal profile; a second user, the second user having permission to view all of the animal profile and permission to edit at least a portion of the animal-specific information in the animal profile; and a third user, the third user having permission to view at least a portion of the animal profile, and the third user being prohibited from viewing at least a portion of the guardian profile.

Implementations may include one or more of the following features. The method may further include, in response to receiving the unique identifier retrieved by scanning the tag, automatically activating a found animal indicator for the animal having the animal profile associated with the unique identifier. The found animal indicator may only be activated when the unique identifier is received from one or more of the second user and the third user. The method may further include automatically transmitting a notification to one or more of the guardian and the first user upon activation of the found animal indicator. The notification may include contact information for a user that transmitted the unique identifier. The notification may include a location of a device that transmitted the unique identifier. The user interface may include a missing pet indicator, and one or more of the first user and the guardian may have permission to activate the missing pet indicator. When the second user is associated with at least one of a predetermined accreditation and the animal profile, the second user may have permission to edit all of the animal profile. The method may further include querying a database for at least one of a predetermined accreditation and a permission status of a user attempting to access information within the user interface. The method may further include: determining whether the user is the first user, the second user, or the third user based on the at least one of the predetermined accreditation and the permission status. The method may also include providing permissions for access to the information in the user interface according to the determination. Permissions for interaction with the animal profile may be editable by one or more of the guardian and the first user in the user interface. Permissions for interaction with the guardian profile may be editable by one or more of the guardian and the first user in the user interface. Permissions for one or more of the first user, the second user, and the third user may be customizable by the guardian in the user interface. Permissions for one or more of the second user and the third user may be customizable by one or more of the guardian and the first user in the user interface. The method may further include automatically transmitting a notification to one or more of the guardian and the first user upon retrieving the unique identifier. The animal may be a pet, and the guardian may be an owner of the animal. The first user may be the guardian. The first user may be one or more of the guardian, a veterinarian of record for the animal, and an administrator for the user interface. The second user may be one or more of a veterinarian office, an animal hospital, a government entity, and a shelter. A user may be required to have a predetermined accreditation to become one or more of the first user and the second user. The third user may be one or more of an unknown user and an unaccredited user. The third user may be prohibited from viewing all of the guardian profile. The method may further include tagging the animal with the tag. The tag may include one or more of an integrated circuit, a microchip, and a nanochip. The tag may be implanted within tissue of the animal. The method may further include scanning the tag to retrieve the unique identifier; transmitting the unique identifier over the data network to the remote computing resource; and retrieving, by the remote computing resource, the animal profile associated with the unique identifier. The method may also include displaying, via the user interface, at least a portion of one or more of the animal profile and the guardian profile. The user interface may include a tabbed document interface for one or more of the animal profile and the guardian profile. A portion of the unique identifier may indicate compatibility with a platform including the user interface. The portion of the unique identifier may include a predetermined alphabetic sequence. The user interface may be accessible to one or more of the first user and the second user without scanning the tag. The method may further include receiving an edit to one or more of the animal profile and the guardian profile, and transforming data associated with the edit to a different format for inclusion on the user interface.

In an aspect, a computer program product for processing animal records disclosed herein may include computer executable code embodied in a non-transitory computer readable medium that, when executing on one or more computing devices, performs the steps of: receiving a unique identifier associated with a tag, the tag scannable via a tag sensor to retrieve the unique identifier; creating an animal profile associated with the unique identifier; associating the animal profile with a guardian profile, the guardian profile including at least contact information for a guardian associated with an animal included in the animal profile; storing animal-specific information for the animal in the animal profile, the animal-specific information including at least one of a vaccination record, a medical procedure record, a current treatment, health history, a certification, a dietary restriction, animal breed information, and genetic information; and providing a user interface for accessing at least a portion of one or more of the animal profile and the guardian profile. Information within the user interface may be configured for access by each of: a first user associated with the guardian profile, the first user having permission to edit the guardian profile and at least a portion of the animal profile and permission to view all of the animal-specific information in the animal profile; a second user, the second user having permission to view all of the animal profile and permission to edit at least a portion of the animal-specific information in the animal profile; and a third user, the third user having permission to view at least a portion of the animal profile, and the third user being prohibited from viewing at least a portion of the guardian profile.

In an aspect, a system for processing and storing animal records disclosed herein may include: a tag scannable via a tag sensor to retrieve a unique identifier associated with the tag; a data network; a user device having a display, the user device coupled to the data network; a database configured to store animal records; and a remote computing resource coupled to the data network and hosting a user interface configured for the display, the user interface accessible by the user device through the data network, and the database in communication with the remote computing resource. The remote computing resource may include a processor and a memory, the memory storing code executable by the processor to perform the steps of: receiving the unique identifier over the data network; creating an animal profile associated with the unique identifier; associating the animal profile with a guardian profile, the guardian profile including at least contact information for a guardian associated with an animal included in the animal profile; storing animal-specific information for the animal in the animal profile, the animal-specific information including at least one of a vaccination record, a medical procedure record, a current treatment, health history, a certification, a dietary restriction, animal breed information, and genetic information; and controlling access to at least a portion of one or more of the animal profile and the guardian profile according to a permission status. The permission status may include: first permissions for a first user associated with the guardian profile, the first permissions including an ability to edit the guardian profile and at least a portion of the animal profile and an ability to view all of the animal-specific information in the animal profile; second permissions for a second user, the second permissions including an ability to view all of the animal profile and an ability to edit at least a portion of the animal-specific information in the animal profile; and third permissions for a third user, the third permissions including an ability to view at least a portion of the animal profile, and a prohibition from viewing at least a portion of the guardian profile.

In an aspect, a method for a guardian of an animal to provide access to animal records for the animal as disclosed herein may include: initiating tagging of the animal with a tag, the tag scannable via a tag sensor to retrieve a unique identifier; providing the unique identifier, over a data network, to a remote computing resource; configuring an animal profile associated with the unique identifier; configuring a guardian profile including at least contact information associated with a guardian of the animal; configuring a permission status related to access of at least one of the animal profile and the guardian profile via a user interface hosted by the remote computing resource; and retrieving, according to the permission status and via the user interface, at least a portion of one or more of the animal profile and the guardian profile. The permission status may include: first permissions for a first user associated with the guardian profile, the first permissions including an ability to edit the guardian profile and at least a portion of the animal profile and an ability to view all animal-specific information in the animal profile; second permissions for a second user, the second permissions including an ability to view all of the animal profile and an ability to edit at least a portion of the animal-specific information in the animal profile; and third permissions for a third user, the third permissions including an ability to view at least a portion of the animal profile, and a prohibition from viewing at least a portion of the guardian profile.

In an aspect, a tag for an animal as disclosed herein may include: an enclosure structurally configured for implantation within tissue of an animal; and a communications interface configured to transmit a signal including a unique identifier in response to scanning by a tag sensor configured to communicate the unique identifier to a remote computing resource over a data network. An initial transmission of the unique identifier from the tag to the remote computing resource may initiate creation, by the remote computing resource, of an animal profile associated with the unique identifier. The animal profile may be associated with a guardian profile, the guardian profile including at least contact information for a guardian associated with the animal. Animal-specific information for the animal may be stored in the animal profile, the animal-specific information including at least one of a vaccination record, a medical procedure record, a current treatment, health history, a certification, a dietary restriction, animal breed information, and genetic information. At least a portion of the animal profile and the guardian profile may be accessible over the data network via a user interface hosted by the remote computing resource. Information within the user interface may be configured for access by each of: a first user associated with the guardian profile, the first user having permission to edit the guardian profile and at least a portion of the animal profile and permission to view all of the animal-specific information in the animal profile; a second user, the second user having permission to view all of the animal profile and permission to edit at least a portion of the animal-specific information in the animal profile; and a third user, the third user having permission to view at least a portion of the animal profile, and the third user being prohibited from viewing at least a portion of the guardian profile.

These and other features, aspects, and advantages of the present teachings will become better understood with reference to the following description, examples, and appended claims.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 shows a system for animal records, in accordance with a representative embodiment.

FIG. 2 shows a tag for an animal, in accordance with a representative embodiment.

FIG. 3 is a flow chart of a method for processing animal records, in accordance with a representative embodiment.

FIG. 4 is a flow chart of a method for providing access to animal records, in accordance with a representative embodiment.

FIG. 5 shows a user interface including a missing pet indicator, in accordance with a representative embodiment.

FIG. 6 shows an interactive screen of a user interface, in accordance with a representative embodiment.

FIG. 7 shows a user interface including an alert dialog, in accordance with a representative embodiment.

FIG. 8 shows another interactive screen of a user interface, in accordance with a representative embodiment.

FIG. 9 shows a user interface including medical records, in accordance with a representative embodiment.

FIG. 10 shows a user interface including an incident summary, in accordance with a representative embodiment.

FIG. 11 shows a user interface including instructions for a guardian, in accordance with a representative embodiment.

FIG. 12 shows an interactive screen of a user interface for vaccination records, in accordance with a representative embodiment.

FIG. 13 shows a user interface including a detailed vaccination record, in accordance with a representative embodiment.

FIG. 14 shows another user interface for vaccination records, in accordance with a representative embodiment.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

In general, the devices, systems, and methods disclosed herein relate to animal records, e.g., processing and storing animal records, and/or providing access thereto. Thus, the present disclosure generally relates to medical record storage and retrieval technology for animals, including companion animals (i.e., pets) and the like. More particularly, the present disclosure relates to the storage and retrieval of animal records, and an interface for interacting with, accessing, and/or viewing animal records and the like.

It will be understood that the present teachings may emphasize the use of information associated with an animal, and that one such animal type includes a companion animal or pet. However, it will be understood that the present teachings may also or instead be used in conjunction with information associated with other types of animals besides pets, including domesticated and/or non-domesticated animals. By way of example, the present teachings may be useful for pets including mammals (e.g., cats, dogs, rabbits, hamsters, guinea pigs, and the like) and non-mammals (e.g., turtles, snakes, lizards, fish, and so on) alike. The present teachings may also or instead be useful for livestock (e.g., cattle, sheep, pigs, goats, and so on) and/or beasts of burden (e.g., horses, camels, donkeys, and so on). Thus, it will be understood that, unless expressly stated to the contrary or otherwise clear from the context, references to “animals” or “pets” in this disclosure shall include any or all of the foregoing animals and animal types.

Currently, within the veterinary industry, there are applications (apps), platforms, and technologies that offer medical record storage services. However, these technologies are generally not standardized, which creates difficulties in who can and who cannot view gathered medical information; often, such information has to be exported and/or converted before sharing and/or accessing. This lack of standardization and accessibility may require valuable time, and can create a lack of cohesiveness in the documentation of animal records. The present teachings may address some or all of these concerns.

For example, many individuals have more than one companion animal, each with its own medical needs and history. This can make record keeping increasingly difficult, given that there is more than one pet, likely with different needs. Owners are not normally given instructions on how to properly store this information, and typically, they are not given all of the documentation that veterinarians and adoption services have acquired. Veterinarians often rely on owners to provide these documents when they first enter the practice, but it is not uncommon that veterinarians only receive the contact information of other offices. In such cases, time on the part of both offices may be required for access to animal records. And, in some circumstances, the owner cannot recall where their pets received treatment, thereby leaving gaps in animal records.

Continuing with this example, even when pet records are available from a veterinarian, this may not guarantee that one office has all of a pet's records. For example, emergency veterinary practices and any veterinarians seen while traveling are often one-time visits, where any of the information that they have stored likely does not contain information sent from other practices. Therefore, if they are asked for records, they will not be able to supply the full picture. This can be a challenge in that back-tracking may need to occur in order to obtain all of a pet's known history.

Moreover, animals that are pure-bred often can have health issues that are related to genetics. Therefore, having genetic information, such as the breed of the animal, can inform others on what to be on the lookout for as far as breed-specific and breed-prone illnesses are concerned. With the use of DNA tests and kits on the rise, this information can be utilized to help determine potential areas of concern for the pet as its life continues. This type of information is not normally included in other forms of documentation technology, but may be included in the present teachings.

Some or all of the concerns and difficulties stated above may be addressed by the present teachings, which may include a technology solution that ensures that animals have records that are secure and simple for their caregivers (and/or other persons/entities of interest) to access immediately at any point in time from anywhere. The present teachings may thus include a technological service that stores all relevant medical, genetic, and certification information pertaining to an individual animal through a secure, organized, and easily-accessible database. The present teachings may offer a convenient, reliable method of documentation organization, and may include the ability to upload any and all information that pertains to an animal in an easy-to-find, accessible format will make life more convenient for everyone involved in an animal's life.

A brief overview of an implementation of the present teachings will now be described. Using a platform that includes functionality of the present teachings, an account may be started during the beginning of an animal's life, or when the animal first reaches a shelter or similar. All of the animal's adoption records, medical records, certifications, x-rays, and/or other documentation can be uploaded onto a platform that includes functionality of the present teachings, which may be accessible via a mobile application (app) or computer program. Further, any images of wounds, deformities, and/or other health-related images can also or instead be uploaded onto this technology. Additionally, breeding records, history, and/or personal information can be uploaded onto the account as well. This may keep all information that is relevant to the animal in one place. In certain implementations, this information can be accessed through scanning a chip implanted in the animal, where such a chip may contain an identification code leading to a platform that includes functionality of the present teachings, e.g., via an online system.

The present teachings may also or instead include a system of tab filing that can help to keep all of the records straight and categorized in an understandable fashion. These tabs can be customized to fit the medical needs of an animal. For example, if an animal was hit by a car or otherwise in an incident such as an accident, all of the relevant x-rays, documents, and images can be filed under a tab that is labeled with an identifier for the incident (e.g., “Sep. 23, 2020 Hit By Car” tab), regardless of whether they are from the general veterinarian or emergency veterinarian, from the procedure or from the post-care. This can also be used for long-term issues, such as diabetes, thyroid disease, and so on.

Thus, using the present teachings, with the scan of a chip, anyone may be able to view an animal's information. And, if a scanner is not present, the information may be accessed by inputting information (e.g., a chip's I.D. code) into a platform that includes functionality of the present teachings. This action may reveal any and all files stored on a platform that includes functionality of the present teachings, subject to permissions as disclosed herein.

In some implementations, not just anyone can edit an animal's records. For example, each owner, animal shelter, and/or veterinary practice may receive a login code that they must enter into the system prior to inputting information (e.g., a chip's I.D. code) into a platform that includes functionality of the present teachings. This may enable certain users to edit certain parts of the information stored thereon. For example, while owners may be able to upload pictures, images, and comments pertaining to their pet's health, only veterinarians may be able to upload official medical documents.

Therefore, certain implementations may include a system and/or platform configured for storing and/or transmitting animal records, such as a pet's history and veterinary records. And in certain aspects, the present teachings couples tag information (e.g., utilizing radio-frequency identification (RFID) technology) with a database and platform, thereby enabling an animal's records to be accessed any time by certain users such as veterinarians, animal shelter employees, and/or a guardian. The present teachings may thus save time, increase human and animal safety, and provide peace of mind for guardians and/or employees. The present teachings may also or instead improve upon techniques for reuniting lost animals with their guardians.

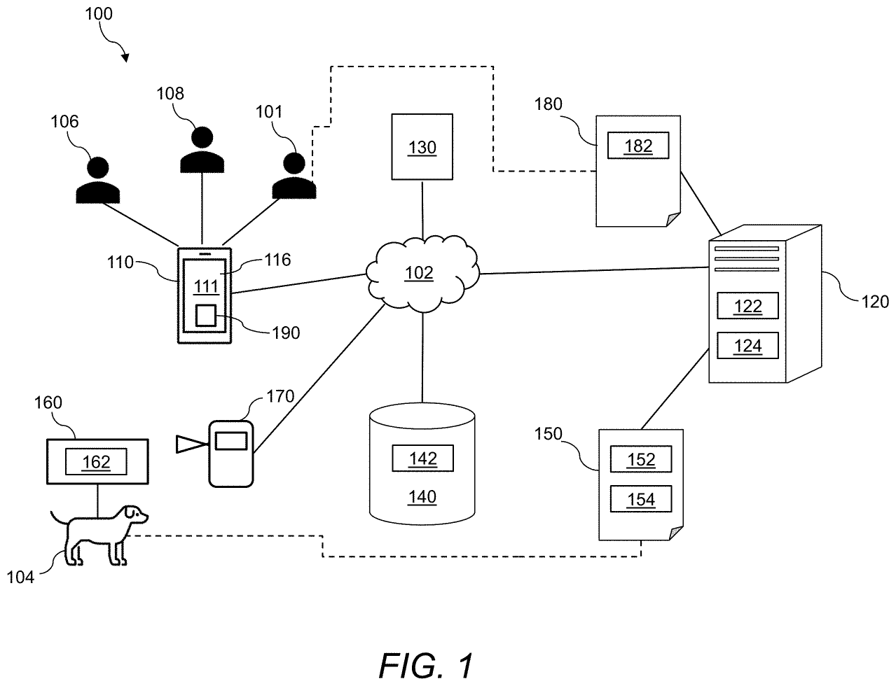

FIG. 1 shows a system for animal records, in accordance with a representative embodiment—e.g., a system 100 for processing and storing animal records. More particularly, the system 100 may be used for creating an animal profile 150 associated with a unique identifier 162 retrievable by scanning a tag 160, and controlling access by different users to at least a portion of the animal profile 150. For example, animal-specific information 152 may be stored in the animal profile 150. Further, the animal profile 150 may be associated with a guardian profile 180, which may include information such as contact information 182 for a guardian of the animal 104.

In general, the system 100 may include a networked environment where a data network 102 interconnects a plurality of participating devices and/or users in a communicating relationship. The participating devices may, for example, include any number of user devices 110, remote computing resources 120, and other resources 130. Generally, the system 100 may be used for any of the implementations of the present teachings described herein. For example, the system 100 may be used for retrieving a unique identifier 162 associated with a tag 160 worn by an animal 104 and transmitting the unique identifier 162 over the data network 102 to create and/or access an animal profile 150 associated with the unique identifier 162 and thus the animal 104. More specifically, in the system 100, a user, such as a first user 101, a second user 106, and/or a third user 108, may scan the tag 160 with a tag sensor 170 to retrieve the unique identifier 162 associated with the tag 160, transmit that unique identifier 162 over the data network 102 to a remote computing resource 120 for processing the animal profile 150 associated with the unique identifier 162, where the remote computing resource 120 controls access to the animal profile 150 and to a guardian profile 180 associated with the animal profile 150 according to a permission status of the accessing user. This entire process can be done relatively quickly, e.g., in near real-time (such as less than five minutes, less than one minute, or mere seconds). Certain participants and aspects of the system 100 will now be described.

The animal 104 may be any as described herein—e.g., a domesticated animal (such as a pet, companion animal, or livestock animal), a zoo animal, or another non-human animal under the care of a human or similar. In general, the animal 104 may be tagged with (e.g., by implantation or external attachment) the tag 160 having the unique identifier 162. By virtue of having the tag 160, the animal 104 may thus be considered to be associated with the unique identifier 162 of the tag 160.

The first user 101 may be associated with the animal 104. For example, the first user 101 may include a pet's guardian, a livestock owner, a shelter that houses rescue animals, a zookeeper, and/or another primary caretaker of the animal 104. In some cases, the first user 101 may be the guardian of the animal 104. It will be understood that the term “guardian” as used herein shall include a caretaker of the animal 104, for example including an animal's owner or otherwise someone that is responsible for the animal 104 or otherwise closely associated with the animal 104. In other cases, such as where the first user 101 is an animal shelter, the first user 101 may only temporarily be a primary caretaker of the animal 104. A guardian or the first user 101 may initiate tagging the animal 104 with the tag 160. The physical tagging of the animal 104 may be performed by a user of the system 100 or by an outside party.

In addition to the first user 101, a second user 106 and/or a third user 108 may also or instead interact with the system 100. Examples of the second user 106 or the third user 108 include veterinary practices, animal hospitals, animal shelters, boarders, groomers, trainers, pet sitters, breeders, insurance companies, other animal industry affiliates, and the like. A specific user, such as an animal shelter, may in some instances be a second user 106 while in other instances be a first user 101 or a third user 108, depending upon the specific configuration and permissions of the animal profile 150 being accessed, and the specific relationship to the animal 104 (or lack of such a relationship) for such user(s). The second user 106 and the third user 108 may each have permission statuses that differ from the permission status of the first user 101.

As use herein, the terms “first user,” “second user,” and “third user” will be understood to refer to a type or class of user, where any type of user may include multiple specific individuals and/or one or more classes of individual. For example, a guardian of a pet, a veterinarian of record for the animal 104, and an administrator for the user interface may each be considered a first user 101 and may have identical, or similar, levels of access to aspects of the system 100. A first user 101 may have legal ownership of the animal 104, such as an individual who owns a pet, a pet foster organization, or a pet breeder.

Each of the first user 101, second user 106, and third user 108 may be associated with one or more specific sets of permissions to access the system 100. Examples of permission types include permission to edit, permission to view (without being able to edit), permission to comment, and permission to access. Example permissions for the first user 101 include permission to edit the guardian profile 180, permission to view all of the animal-specific 152 information in the animal profile 150, and permission to edit at least a portion of the animal profile 150. In general, any user may not have permission to edit elements of the animal profile 150 for which they are not legally responsible for, including vaccinations, prescribed medications, and other information requiring professional medical verification. The first user 101 may have permission to comment on any information in the animal profile 150 for which they may not have permission to otherwise edit. The comments may be visible to some or all of the other users, depending on their permissions.

The second user 106 may include, for example, a veterinarian office, an animal hospital, a government entity, and/or a shelter. The second user 106 may have permissions such as: permission to view all of the animal profile 150 and permission to edit at least a portion of the animal-specific information 152 in the animal profile 150. In some cases, where the second user 106 is associated with at least one of a predetermined accreditation and the animal profile 150, the second user 106 may have permission to edit all of the animal profile 150. In one example, a second user 106 is a veterinarian, such as a veterinary hospital, veterinary clinic, veterinary facility, emergency veterinarian, veterinary specialist, general veterinary practice, or the like. A veterinarian account may be required to follow a registration process with the system 100, such as by providing a predetermined accreditation or a credentials check (e.g., state licensing verification). The veterinarian account may include one or more doctors associated with a single practice. Also, or instead, individual doctors may be associated with more than one veterinary practice. The veterinarian account may have permission to view the entirety of the animal profile 150 and permission to edit medical information in the animal profile 150. The veterinarian account may not have permission to edit some information in the animal profile 150 that is instead editable by the first user 101, such as the animal's name, date of birth, or profile picture.

In some cases, a user may be required to have a predetermined accreditation to become one or more of the first user 101 and the second user 106. For example, a veterinarian may provide a credentials check, such as a state license. In another example, a licensed animal shelter or animal rescue organization may be required to provide legal proof of the organization's purpose and/or other information related to the legitimacy of the organization. In the animal shelter example, in relation to one example animal, the animal shelter may be the second user 106, and may have permission to view the entirety of the animal profile 150 and permission to edit medical information in the animal profile 150. In the case of a different animal, the animal shelter may be the first user 101, and may have permission to edit the entirety of the animal profile 150.

The third user 108 may be an unknown user or an unaccredited user. The third user 108 may have limited permissions, such as permission to view only a portion of the animal profile 150, and/or a prohibition from viewing some or all of the guardian profile 180 (e.g., the guardian profile 180 may be hidden from the third user 108). In one example, a third user 108 may be an animal rescue organization whose credentials have not been verified by the system 100. This third user 108 may have found the animal 104, scanned their tag 160, and entered the corresponding unique identifier 162 into the system 100. The third user 108 may then be able to view a portion of the animal profile 150, such as current medical conditions. The third user 108 may be able to take some actions within the platform, such as sending a notification or reporting a current location of the animal 104.

In another example, the third user 108 is a pet industry account, such as a boarder, groomer, trainer, dog walker, pet sitter, or similar. The pet industry account may be able to view animal profile 150 information which is tagged or sorted for their specific industry. The pet industry account may additionally be able to view pertinent medical information in the animal profile 150, such as vaccinations, illnesses, or injuries. The pet industry account may have permission to comment on information that they cannot otherwise edit, for example, to comment regarding a treatment given alongside related injury or illness information. The pet industry account may have permission to edit animal-specific information 152 under the domain of their specific industry (e.g., a groomer may add information to an animal's “Groomer” tab, but not to the “Boarder” tab). In some cases, the pet industry account may not be able to access any of the animal profile 150 except information in their industry-specific tab, the “Vaccinations” tab, and/or the “Injuries and Illnesses” tab. While the pet industry account may view all of those tabs, they may only edit their industry-specific tab and may only comment on the rest. Specific permissions related to third users 108 may be editable by, for example, the first user 101, the second user 106, the user responsible for the information related to the permission, and/or an administrator of the system 100.

In another example, the third user 108 is a pet insurance company. In some aspects, legal verification of the account holder's function may be required to create a pet insurance account. The pet insurance company may only have permission to view a “Procedure History” tab for verification of veterinary bills or the like. The pet insurance company may not have permission to view any other parts of the animal profile 150 or any of the guardian profile 180. The pet insurance company may not have permission to edit or comment on any part of the animal profile 150.

In another example, a user may be a farm account, such as a commercial farm, a hobby farm, or a companion animal farm. The farm account may be associated with one or more animals 104 including cattle, horses, swine, sheep, goats, and others. The farm account may be a first user 101 and may be associated with a plurality of animal profiles 150, such as 5, 25, 100, or 1000 animal profiles 150. In the event that animals 104 are sold or slaughtered, farm accounts may be able to save animal profiles 150 associated with those animals 104, for example in the database 140 or on the user device 110. This feature enables farms to view past information related to their organization. The farm account may be able to view the entirety of each of their associated animal profiles 150. The user interface 116 for a farm account may have the ability to organize animal profiles 150 by animal type, animal breed, age, or custom group. The farm account may have permission to edit elements in any tab not classified as a “Medical Tab” or any information that does not require professional verification. Data that cannot be edited by farm accounts may be commented on. All edits and comments made by the farm account may be viewed by any other user types, depending on their permissions.

In another example, a user may be a zoo account, which may be held by any licensed zoo, petting zoo, or other establishment which profits from displaying animals to the public. The zoo account may be configured similarly to the farm account.

In another example, a user may be a licensed breeder of domesticated animals. Legal verification of the business may be required in order to be considered a first user 101 or a second user 106. Thus, the breeder account may be a first user 101 or a second user 106, and may be associated with a plurality of animal profiles 150, such as 5, 10, 25, or 50 animal profiles 150. In the event that animals 104 are sold, breeder accounts may be able to save animal profiles 150 associated with those animals, for example in the database 140 or on the user device 110. This feature enables breeders to view past information related to their business. The breeder account may be able to view the entirety of all of their associated animal profiles 150. The user interface 116 for such an account may have the ability to organize animal profiles 150 by animal type, animal breed, age, or custom group. The breeder account may have permission to edit elements in any tab not classified as a “Medical Tab” or any information that does not require professional verification. Data that cannot be edited by breeder accounts may be commented on by the breeder. All edits and comments made by the breeder account may be viewed by any other user types, depending on their permissions.

The tag 160 may be a device structurally configured to be implanted within tissue of the animal 104—e.g., within a layer of skin of the animal 104. Alternatively, the tag 160 may be configured to be externally attached to the animal 104 or otherwise coupled to the animal 104, such as where the tag 160 includes an ear tag, a leg band, a collar or accoutrement thereof, and the like. In general, the tag 160 may be scannable by a tag sensor 170 to retrieve the unique identifier 162 associated with the tag 160. The tag 160 may include one or more of an integrated circuit, a microchip, a nanochip, and the like. For example, the tag 160 may include a passive transponder, such as a radio transponder.

The tag sensor 170 may be a device, such as tag reader or scanner, for sensing and/or interrogating the tag 160 to obtain the unique identifier 162 associated with the tag 160. In an example case, the tag sensor 170 may transmit a radio frequency signal (e.g., 125 kHz or 134.2 kHz frequencies) designed to interrogate a tag 160 having a radio transponder. The tag sensor 170 may display at least a part of the reply received in response to the interrogation; for example, the tag sensor 170 may display the unique identifier 162 received in response to interrogating the tag 160. Alternatively, or in addition, the tag sensor 170 may be in communication with the data network 102 and may transmit the unique identifier 162 via the data network 102. The tag sensor 170 may also or instead be in communication with another participant of the system 100, where such a participant transmits the unique identifier 162 via the data network 102. In some implementations, the tag sensor 170 provides information that is readable by a computing device and/or a user to otherwise transmit the unique identifier 162 to a remote computing resource 120 via the data network 102 or otherwise. The tag sensor 170 may also or instead use other sensing techniques to retrieve the unique identifier 162, such as other electromagnetic sensing methods or optical scanning.

The animal profile 150 may be created (e.g., stored as data 142 in the database 140) in association with one or both of the animal 104 and the unique identifier 162. In some cases, the animal profile 150 may be initially created in association with an animal 104, either prior to tagging or prior to entry of the unique identifier 162 into the system 100. In other cases, the animal profile 150 may be initially created in association with the unique identifier 162, e.g., prior to the tag 160 being associated with an animal 104. In either case, information associated with the animal 104 or the tag 160 may be entered upon or after creation of the animal profile 150. The animal profile 150 may be created automatically, for example, the act of a remote computing resource 120 receiving, over the data network 102, a unique identifier 162 that is not associated with an animal profile 150 may trigger the remote computing resource 120 to create a new animal profile 150 for association with the unique identifier 162.

The animal profile 150 may store or otherwise be associated with animal-specific information 152 related to the animal 104. Examples of animal-specific information 152 may include, without limitation, one or more of a vaccination record, a medical procedure record, current or past treatment plans, health history data, a certification, a dietary restriction (or other diet information), allergy information, animal breed information, genetic information, and the like. Information within the animal profile 152 may be accessible in different ways (e.g., for viewing, for editing, or hidden) depending on permissions associated with the user accessing the system 100. To facilitate permission-based access, information within the animal profile 152 may be labeled, categorized, have associated metadata, or be otherwise marked or sorted.

The guardian profile 180 may be created (e.g., stored as data 142 in the database 140) by the remote computing resource or by a user interacting with system 100. The guardian profile 180 may store or otherwise be associated with data related to a guardian, for example, contact information 182 for a guardian. Such contact information may include one or more of a name, an address, a phone number, an email address, and the like. The guardian profile 180 may be associated with one or more animals 104, each of which may have an associated animal profile 150. The first user 101 may be associated with the guardian profile 180. And, in certain aspects, at least the first user 101 of the system 100 has permission to edit the guardian profile 180. In some cases, the first user 101 may grant or limit permissions for a second user 106 and/or a third user 108 to view or edit at least a portion of the guardian profile 180. In some cases, the second user 106 and/or the third user 108 may not have permissions to view a portion of, or the entirety of, the guardian profile 180. In other words, the guardian profile 180 may be partially or completely hidden from the second user 106 and/or the third user 108. In this case, the guardian profile 180 would appear similarly to a “ghost profile” or an anonymous user profile that other users may only communicate with through the system 100, as opposed to directly being viewable to other users. This feature can protect the guardian's identity and can ensure that the system 100 will not be violating any privacy laws surrounding the guardian.

The data network 102 may be any network(s) or internetwork(s) suitable for communicating data and information among participants in the system 100. This may include public networks such as the Internet, private networks, telecommunications networks such as the Public Switched Telephone Network or cellular networks using third generation (e.g., 3G or IMT-2000), fourth generation (e.g., LTE (E-UTRA) or WiMAX-Advanced (IEEE 802.16m)), fifth generation (e.g., 5G), and/or other technologies, as well as any of a variety of corporate area or local area networks and other switches, routers, hubs, gateways, and the like that might be used to carry data among participants in the system 100.

Each of the participants of the data network 102 may include a suitable network interface comprising, e.g., a network interface card, which term is used broadly herein to include any hardware (along with software, firmware, or the like to control operation of same) suitable for establishing and maintaining wired and/or wireless communications. The network interface card may include without limitation a wired Ethernet network interface card (“NIC”), a wireless 802.11 networking card, a wireless 802.11 USB device, or other hardware for wired or wireless local area networking. The network interface may also or instead include cellular network hardware, wide-area wireless network hardware or any other hardware for centralized, ad hoc, peer-to-peer, or other radio communications that might be used to connect to a network and carry data. In another aspect, the network interface may include a serial or USB port to directly connect to a local computing device such as a desktop computer that, in turn, provides more general network connectivity to the data network 102.

The user devices 110 may include one or more devices within the system 100 operated by one or more users for practicing the techniques as contemplated herein. The user devices 110 may thus be coupled to the data network 102. Specifically, the user devices 110 may include any device for accessing at least a portion of the animal profile 150 or the guardian profile 180 for viewing or editing, transmitting (e.g., over the data network 102) animal-specific information 152 for storage in the animal profile 150 (e.g., in the database 140), or retrieving the unique identifier 162 associated with the tag 160. To this end, the user device 110 may include a display 111 for viewing data such as one or more of the profiles as described herein, and/or for interacting with a platform as described herein via a user interface 116. Further, in some aspects, the user device 110 may include a tag sensor 170 or the like, or the user device 110 may otherwise be in communication with the tag sensor 170 or the like. In one implementation, the user device 110 includes a tag sensor 170 in communication with a smartphone or the like having access to the data network 102. In another implementation, the user device 110 includes a personal computing device or the like having access to the data network 102 (e.g., a smartphone), and the unique identifier 162 may be manually entered via the user device 110 to access the animal profile 150. The user device 110 may also or instead include any device for accessing at least a portion of the animal profile 150 and/or the guardian profile 180 over the data network 102 and displaying accessed information in a user interface 116 (e.g., where the user interface 116 is hosted by the remote computing resource 120).

Similarly, the user device 110 may include any device for creating, preparing, editing, receiving, and/or transmitting other data and/or files in the system 100, such as animal-specific information 152 related to the animal 104, contact information 182 for association with the guardian profile 180, and so on. The user devices 110 may also or instead include any device for managing, monitoring, or otherwise interacting with tools, platforms, and devices included in the systems and techniques contemplated herein. The user devices 110 may be coupled to the data network 102, e.g., for interaction with one or more other participants in the system 100. It will also be understood that all or part of the functionality of the system 100 described herein may be performed on the user device 110 (or another component of the system 100) without a connection to the data network 102—by way of example, a closed network native application on a smartphone may be utilized, whereby functionality (e.g., access to an animal profile 150 or other information stored locally) can run in a closed environment.

By way of further example, the user devices 110 may include one or more desktop computers, laptop computers, network computers, tablets, mobile devices, portable digital assistants, messaging devices, cellular phones, smartphones, portable media or entertainment devices, or any other computing devices that can participate in the system 100 as contemplated herein. As discussed above, the user devices 110 may include any form of mobile device, such as any wireless, battery-powered device, that might be used to interact with the networked system 100. It will also be appreciated that one of the user devices 110 may coordinate related functions (e.g., performing processing and/or retrieving of the animal profile 150 and the like) as they are performed by another entity such as one of the remote computing resources 120 or other resources 130.

Each user device 110 may generally provide a user interface 116 via a display 111. The user interface 116 may be maintained by a locally-executing application on one of the user devices 110 that receives data from, for example, the remote computing resources 120 or other resources 130. In other embodiments, the user interface 116 may be remotely served and presented on one of the user devices 110, such as where a remote computing resource 120 or other resource 130 includes a web server that provides information through one or more web pages or the like that can be displayed within a web browser or similar client executing on one of the user devices 110. The user interface 116 may in general create a suitable visual presentation for user interaction on a display 111 of one of the user devices 110, and provide for receiving any suitable form of user input including, e.g., input from a keyboard, mouse, touchpad, touch screen, hand gesture, or other user input device(s).

The remote computing resources 120 may include, or otherwise be in communication with, a processor 122 and a memory 124, where the memory 124 stores code executable by the processor 122 to perform various techniques of the present teachings. More specifically, a remote computing resource 120 may be coupled to the data network 102 and accessible to the user device 110 through the data network 102, where the remote computing resource 120 includes a processor 122 and a memory 124, where the memory 124 stores code executable by the processor 122 to perform the steps of a method according to the present teachings—such as any of the methods or techniques described herein.

The remote computing resources 120 may also or instead include data storage, a network interface, and/or other processing circuitry. In the following description, where the functions or configuration of a remote computing resource 120 are described, this is intended to include corresponding functions or configuration (e.g., by programming) of a processor 122 of the remote computing resource 120, or in communication with the remote computing resource 120. In general, the remote computing resource 120 (or processors 122 thereof or in communication therewith) may perform a variety of processing tasks related to processing and storing animal records 150 and controlling access to the animal record 150 (or other records and data) as discussed herein. For example, the remote computing resource 120 may manage information received from one or more of the user devices 110 (e.g., animal-specific information 152, contact information 182 for a guardian, and so on), and provide related supporting functions such as creating the animal profile 150, assigning, configuring, or monitoring permission status of users, transforming and/or formatting information provided to the animal profile 150, retrieving and/or analyzing information from a database 140 and/or the memory 124 (e.g., portions of the animal profile 150 or the guardian profile 180), communicating with other resources 130 and the participants in the system 100, storing data, and the like. The remote computing resources 120 may also or instead include backend algorithms that react to actions performed by a user at one or more of the user devices 110. These backend algorithms may also or instead be located elsewhere in the system 100.

The remote computing resources 120 may also or instead include a web server or similar front end that facilitates web-based access by the user devices 110 to the capabilities of the remote computing resource 120 or other components of the system 100. A remote computing resource 120 may also or instead communicate with other resources 130 in order to obtain information for providing to a user through a user interface 116 on the user device 110. Where the user specifies certain criteria for analysis or otherwise, this information may be used by a remote computing resource 120 (and any associated algorithms) to access other resources 130. Additional processing may be usefully performed in this context such as recommending certain analyses and processing operations and techniques.

A remote computing resource 120 may also or instead maintain, or otherwise be in communication with, a database 140 of data 142, and optionally with an interface for users at the user devices 110 to utilize the data 142 of such a database 140. Thus, in one aspect, a remote computing resource 120 may include or otherwise communicate with a database 140 of data 142, and the remote computing resource 120 may act as a server that provides a platform for selecting and using such data 142, and/or providing supporting services related thereto. The database 140 may be a local database of the remote computing resource 120, or a remote database to the remote computing resource 120 or another participant in the system 100. Thus, the database 140 may include a cloud-based database or the like. The database 140 may be specifically configured to store animal records and/or other records/data as described herein.

A remote computing resource 120 may also or instead be configured to manage access to certain content (e.g., for a particular user—such as one or more of the first user 101, the second user 106, and the third user 108). In one aspect, a remote computing resource 120 may manage access to a component of the system 100 by a user device 110 according to input from a user.

In an aspect, many of the techniques of the present teachings are performed by the remote computing resource 120. However, it will be understood that some of the features and functionality described with reference to the remote computing resource 120 may also or instead be performed by another participant in the system 100.

The other resources 130 may include any resources that can be usefully employed in the devices, systems, and methods as described herein. For example, these other resources 130 may include without limitation other data networks, human actors (e.g., programmers, researchers, annotators, editors, analysts, and so forth), sensors (e.g., audio or visual sensors), data mining tools, computational tools, data monitoring tools, algorithms, and so forth. The other resources 130 may also or instead include any other software or hardware resources that may be usefully employed in the networked applications as contemplated herein. For example, the other resources 130 may include payment processing servers or platforms used to authorize payment for access, content, or option/feature purchases, or otherwise. In another aspect, the other resources 130 may include certificate servers or other security resources for third-party verification of identity, encryption or decryption of data, and so forth. In another aspect, the other resources 130 may include a desktop computer or the like co-located (e.g., on the same local area network with, or directly coupled to through a serial or USB cable) with one of the user devices 110 or remote computing resources 120. In this case, the other resource 110 may provide supplemental functions for the user device 110 and/or remote computing resource 120. Other resources 130 may also or instead include supplemental resources such as cameras, scanners, printers, input devices, and so forth.

The other resources 130 may also or instead include one or more web servers that provide web-based access to and from any of the other participants in the system 100. While depicted as a separate network entity, it will be readily appreciated that the other resources 130 (e.g., a web server) may also or instead be logically and/or physically associated with one of the other devices described herein, and may, for example, include or provide a user interface for web access to a remote computing resource 120 or a database 140 in a manner that permits user interaction through the data network 102, e.g., from a user device 110.

It will be understood that the participants in the system 100 may include any hardware or software to perform various functions as described herein. For example, one or more of the user device 110 and the other resources 130 may include a memory 124 and a processor 122.

The various components of the networked system 100 described above may be arranged and configured to support the techniques, processes, and methods described herein in a variety of ways. For example, in one aspect, a user device 110 connects through the data network 102 to a server (e.g., that is part of one or more of the remote computing resource 120 or other resources 130) that performs a variety of processing tasks related to processing records for an animal 104 in an associated animal profile 150 and/or guardian profile 180. For example, the remote computing resource 120 may include a server that hosts a website (and/or a mobile application or application programming interface) that runs a platform for providing a user interface 116 for accessing at least a portion of the animal profile 150 and/or the guardian profile 180. More specifically, a user associated with the user device 110 and having appropriate permissions for using the system 100 may use the user device 110 to transmit data—e.g., animal-specific information 152 and/or guardian contact info 182—over the data network 102 to the remote computing resource 120. The remote computing resource 120 may receive the information from the user over the data network 102 for processing thereof, where an output of the processing may include editing the data, transforming the data, updating a profile, transmitting a notification, or other as described herein.

In some circumstances, the system 100 may transmit a notification 190. For example, a notification 190 may be a phone call, email, and/or text message (e.g., SMS message) transmitted to first user 101, by the remote computing resource 120, over the data network 102. The notification 190 may be displayed on the user interface 116 of the user device 110.

Thus, and as described throughout the present disclosure, a remote computing resource 120 coupled to the data network 102 and accessible to the user device 110 through the data network 102 may include a processor 122 and a memory 124, where the memory 124 stores code executable by the processor 122 to perform the steps of: receiving the unique identifier 162 over the data network 102; creating an animal profile 150 associated with the unique identifier 162; associating the animal profile 150 with a guardian profile 180, the guardian profile 180 including at least contact information 182 for a guardian associated with an animal 104 included in the animal profile 150; storing animal-specific information 152 for the animal 104 in the animal profile 150, the animal-specific information 152 including at least one of a vaccination record, a medical procedure record, a current treatment, health history, a certification, a dietary restriction, animal breed information, and genetic information; and controlling access to at least a portion of one or more of the animal profile 150 and the guardian profile 180 according to a permission status, the permission status including: first permissions for a first user 101 associated with the guardian profile 180, the first permissions including an ability to edit the guardian profile 180 and at least a portion of the animal profile 150 and to view an entirety of the animal profile 150; second permissions for a second user 160, the second permissions including an ability to view an entirety of the animal profile 150 and an ability to edit at least a portion of the animal-specific information 152 in the animal profile 150; and third permissions for a third user 108, the third permissions including an ability to view at least a portion of the animal profile 150, and prohibiting the third user 108 from viewing at least a portion of the contact information 182 associated with the guardian.

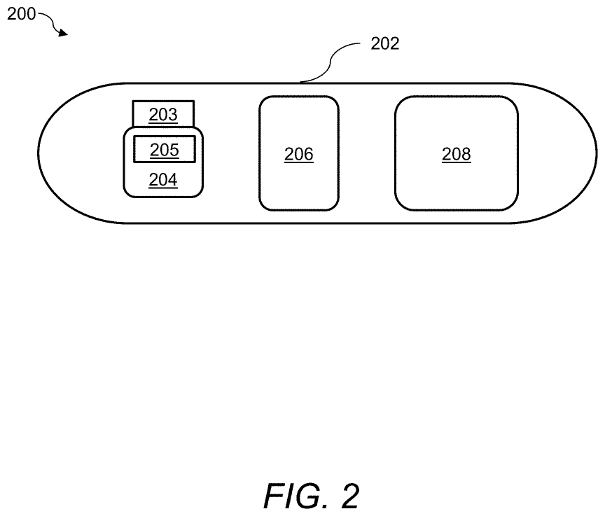

FIG. 2 shows a tag for an animal, in accordance with a representative embodiment. The tag 200 may generally be associated with an animal such as any of those described herein, where the tag 200 is scannable via a tag sensor or the like to retrieve information related to the animal and/or a user/entity associated therewith. The tag 200 may generally include an enclosure 202, a communications interface 203, an integrated circuit 204, an energy storage device 206, and associated electronics 208.

The enclosure 202 may be structurally configured for implantation within tissue of an animal. For example, the enclosure 202 may be formed of a biocompatible material. Also or instead, the enclosure 202 may be sized and shaped (e.g., minimally sized) to reduce potential for discomfort or irritation for an animal. The enclosure 202 may otherwise be structurally configured for engaging with and/or coupling to an animal, e.g., internally or externally.

The communications interface 203 may be any as described herein. By way of example the communications interface 203 may include a transponder—e.g., a passive transponder, such as a radio transponder. In general, the communications interface 203 may be configured to transmit a signal and/or data to another device such as a tag reader/tag sensor. In this manner, the communications interface 203 may be configured for interaction with a RFID sensor/reader/interrogator or the like. Thus, in certain aspects, the tag 200 may passively transmit information (and, as such, in certain aspects the tag 200 may not have an on-board power source). It will be further understood that, the integrated circuit 204, the energy storage device 206, and the associated electronics 208 may together comprise the communications interface 203 that is configured to transmit a signal including a unique identifier 205 associated with the tag 200 as described herein.

The unique identifier 205 may be any as described herein. The unique identifier 205 may be distinguishable from other tag's identifiers, e.g., through the inclusion of a predetermined prefix or other portion of the unique identifier 205. For example, the unique identifier 205 may include a portion thereof with a predetermined alphabetic, alphanumeric, numeric, or otherwise that identifies a platform according to the present teachings. By way of further example, the tag 200 may be distinguishable from other microchips on the market by having the letters “PR” preceding the numerical code, which can inform the user scanning the animal that it has an account on a platform according to the present teachings. Other prefixes are also or instead possible, and/or other identifiers within a code that may not necessarily be a prefix.

The integrated circuit 204 may include a microchip and/or a nanochip. In aspects, a nanochip may be advantageous because the chipping procedure may be less painful, and therefore more ethical, for an animal since the nanochip's needle may be about one-third the size of a microchip's needle. The tag 200 may be produced with sterilized biodegradable implanting syringes, which can increase the sustainability and minimize the risk of issues arising during the implanting procedure.

The energy storage device 206 may include any as known in the art such as a capacitor, which may be activated by a tag scanner or the like. The energy storage device 206 may also or instead include a battery.

Associated electronics 208 may include, for example, an antennae or the like that may enable the tag 200 to communicate with a tag sensor or the like.

An example use case of the tag 200 will now be described. In some aspects, the tag 200 may be implanted under the skin of an animal. Any standard RFID scanner can be passed over the tag 200 to obtain the unique identifier 205 using RFID technology, where the unique identifier 205 may be an alpha-numerical identification code. As discussed above, the tag 200 may be distinguishable from other microchips on the market by having the letters “PR” preceding or otherwise included within the numerical code. This can inform the person of system scanning the animal that it has an account on a platform according to the present teachings.

Continuing with the above use-case example, once obtained, the unique identifier 205 can be searched on a platform according to the present teachings (e.g., a website) using one of at least three account types: for example, an animal shelter account, a veterinary account, or a pet owner account. Each account can upload different elements of an animal's profile, ensuring that users only edit what they are capable of being legally or otherwise responsible for. However, in some aspects, every account type can view all of the information that has been uploaded to an animal's account, such as vaccination history. This can permit owners and the like to be kept in the loop regarding their animal's health, while allowing animal shelters and veterinarians to quickly access details in emergency situations or instances where an animal has been separated from its owner.

Continuing with the above use-case example, in some aspects, while the entirety of the animal's information can be viewed, the attached guardian account/profile may not be viewable to some users. This can protect the guardian's identity and can ensure that a platform will not be violating any privacy laws surrounding the guardian. This can solve an existing issue often found with such microchips/tags—privacy laws may dictate that calls must be made in order to obtain information, rather than visiting a website or the like.

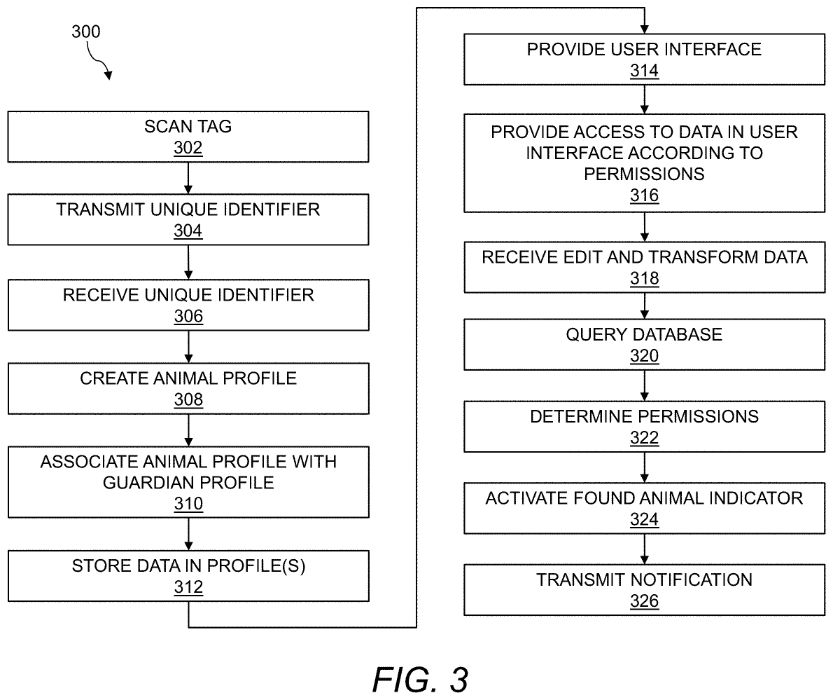

FIG. 3 is a flow chart of a method for processing animal records, in accordance with a representative embodiment. The method 300 may be implemented on a platform such as one supported by any of the systems described herein, such as the system 100 of FIG. 1. Turning back to FIG. 3, as shown in step 302, the method 300 may include scanning a tag, e.g., a tag including one or more of an integrated circuit, a microchip, and a nanochip that is implanted within tissue of the animal. Scanning the tag may retrieve a unique identifier. Thus, the tag may be scannable via a tag sensor to retrieve the unique identifier. For example, the unique identifier may be displayed by, printed by, or stored in memory of a tag sensor capable of scanning the tag. As discussed below, the unique identifier may also or instead be transmitted over a data network, and/or communicated to a computing device that in turn transmits the unique identifier over the data network, e.g., to a remote computing resource. The unique identifier may be any as described herein, and for example may include a specific code that is associated with a predetermined platform of the present teachings. The tag may be scanned in any manner as discussed herein or otherwise known in the art.

As shown in step 304, the method 300 may include transmitting the unique identifier. The unique identifier may be transmitted over a data network to the remote computing resource. A user may transmit the unique identifier, for example by entering the unique identifier into a website. In another instance, the unique identifier may be transmitted automatically, such as by a tag sensor with communications capabilities.

As shown in step 306, the method 300 may include receiving the unique identifier. The unique identifier may be received over a data network by a remote computing resource. In some cases, a portion of the unique identifier may indicate compatibility with a platform including the user interface. For example, the portion of the unique identifier may include a predetermined alphabetic sequence (e.g., “PR” or the like). In some aspects, the act of scanning the tag automatically sets forth a process where the unique identifier is received over a data network by a remote computing resource.

As shown in step 308, the method 300 may include creating an animal profile. The animal profile may be automatically created by the remote computing resource in response to step 306, e.g., where the unique identifier does not yet have an associated animal profile in the system. It will be understood that, in a use-case where the animal profile is already created, this step 308 (and similar steps) may be omitted.

As shown in step 310, the method 300 may include associating the animal profile with a guardian profile. The guardian profile may include at least contact information for a guardian associated with an animal included in the animal profile. The guardian may be any as described herein, and in some aspects, may be a first user as described herein.

As shown in step 312, the method 300 may include storing data in one or more profiles. For example, animal-specific data may be stored in the animal profile, where examples of animal-specific information may include one or more of a vaccination record, a medical procedure record, a current treatment, health history, a certification, a dietary restriction, animal breed information, allergy information, or genetic information. Also or instead, data related to a guardian of the animal, such as contact information, may be stored in a guardian profile. A guardian profile may be associated with one or more animal profiles. Thus, this step 312 may include storing animal-specific information for the animal in the animal profile, the animal-specific information including at least one of a vaccination record, a medical procedure record, a current treatment, health history, a certification, a dietary restriction, animal breed information, allergy information, and genetic information.

As shown in step 314, the method 300 may include providing a user interface. Through the user interface, a user may access some or all of the animal profile, the guardian profile, or both, as well as other information. For example, at least a portion of either the animal profile or the guardian profile may be displayed via the user interface on the display of a user device, such as a computer, tablet, or smartphone. In some instances, the user interface may be accessible by scanning a tag; e.g., receiving the unique identifier from the tag may trigger providing access to the user interface, such as by loading a login screen or opening a homepage. In other instances, the user interface may be accessible to some users (e.g., the first user or the second user as defined herein) without scanning the tag. For example, a user associated with an animal may be able to access data in the animal profile by searching for the animal by name. Thus, the method 300 may include providing a user interface for accessing at least a portion of one or more of the animal profile and the guardian profile from the remote computing resource over the data network, where information within the user interface is configured for access by certain users and/or user types as described herein.

The user interface may include a tabbed document interface for either one or both of the animal profile or the guardian profile. For example, the animal profile may include tabs for different types of pet industry accounts, such as tabs labeled “Boarder,” “Groomer,” “Trainer,” “Dog Walker,” “Pet Sitter,” etc. Different users may have different permissions to edit or permissions to view information under pet industry account tabs. For example, a groomer may have permission to edit information under a pet's “Groomer” tab, but not the “Boarder” tab. The groomer may be allowed to only view information organized under other tabs, such as vaccination, illness, or injury information, which may be organized for example under a “Injuries and Illnesses” tab, or grouped together under a “Medical” tab. In some instances, a user may have permission to leave comments on a tab which they do not have permission to otherwise edit.

As shown in step 316, the method 300 may include providing access to data in the user interface according to permissions. Providing access to the data may include retrieving, e.g., by the remote computing resource, the animal profile associated with a received unique identifier. Information within the user interface may be configured for access by each of a first user, a second user, and a third user as described herein.

The first user may be associated with the guardian profile, and may have permission to edit the guardian profile and at least a portion of the animal profile and permission to view all of the animal-specific information in the animal profile. In some aspects, the first user is the guardian. And, in some aspects, the animal is a pet, and the guardian is an owner of the animal. The first user may also or instead be one or more of the guardian, a veterinarian of record for the animal, and an administrator for the user interface.

In an aspect, permissions for interaction with the animal profile are editable by one or more of the guardian and the first user in the user interface, and/or permissions for interaction with the guardian profile are editable by one or more of the guardian and the first user in the user interface. Also or instead, permissions for one or more of the first user, the second user, and the third user may be customizable by the guardian or the first user in the user interface. For example, permissions for one or more of the second user and the third user may be customizable by one or more of the guardian and the first user in the user interface.

The second user may have permission to view all of the animal profile and permission to edit at least a portion of the animal-specific information in the animal profile. In some aspects, when the second user is associated with at least one of a predetermined accreditation and the animal profile, the second user has permission to edit all of the animal profile. In some aspects, the second user is one or more of a veterinarian office, an animal hospital, a government entity, and a shelter. And in some implementations, a user must have a predetermined accreditation to become one or more of the first user and the second user. Further, a user interface of a platform implementing the method 300 may be accessible to one or more of the first user and the second user without scanning the tag.

The third user may have permission to view at least a portion of the animal profile, but the third user may be prohibited from viewing at least a portion of the guardian profile. In some aspects, the third user is one or more of an unknown user and an unaccredited user. And in some implementations, the third user is prohibited from viewing all of the guardian profile.

In addition to, or instead of, providing access to an animal profile, the user interface may include a missing pet indicator, which may appear as a pop-up window or other type of alert. Certain users, for example the first user or the guardian, may have permission to activate the missing pet indicator. Once activated—and, in some aspects, until deactivated—the missing pet indicator may be displayed to users accessing the animal profile.

As shown in step 318, the method 300 may include receiving an edit and transforming data related to the edit. Receiving an edit may include receiving an edit through the user interface to the animal profile and/or the guardian profile made by a user with appropriate permissions. Transforming data associated with the edit may include reformatting the data, parsing the data, converting a file type, or otherwise altering the data into a suitable format for inclusion on the user interface.

As shown in step 320, the method 300 may include querying a database. A database may be queried for a predetermined accreditation for a user, and/or for a permission status of a user attempting to access information within the user interface. The database may be queried for other user information related to an animal profile, such as an associated guardian profile, medical care provider, pet-service provider, insurance provider, and the like.

As shown in step 322, the method 300 may include determining permissions. For example, determining whether the user is the first user, the second user, or the third user as described herein may be based on a predetermined accreditation, a permission status, and/or a rule of the platform. Access to the information in the user interface may be provided based upon permissions in accordance with this determination. That is, the method 300 may include providing permissions for access to the information in the user interface according to the determination.

As shown in step 324, the method 300 may include activating a found animal indicator. For example, in response to receiving the unique identifier retrieved by scanning the tag, a found animal indicator may automatically be activated for the animal having the animal profile associated with the unique identifier. This feature may be especially beneficial when the found animal indicator is automatically activated when the unique identifier is received from either the second user or the third user. In some cases, the found animal indicator may only be activated if a missing animal indicator is first activated.

As shown in step 326, the method 300 may include transmitting a notification. The notification may be automatically transmitted to either the guardian of the animal and/or the first user associated with the animal profile. The notification may be automatically transmitted upon activation of the found animal indicator. In some instances, the notification may include contact information (or other identifying information) for a user that transmitted the unique identifier. In addition, or instead, the notification may include a location of a device that transmitted the unique identifier.

The notification may be any as described herein or known in the art—e.g., one or more of a phone call (e.g., an automated phone call), a text message, an email, push notification, app notification, and so on. The notification may include appropriate alerts and content regarding same, depending on the situation.

In some cases, automatically transmitting a notification to either the guardian or the first user may occur upon retrieving the unique identifier. In other words, a notification may be sent every time the animal profile is accessed. Users may be able to modify the desired frequency and/or delivery method for notifications in their user profiles. In some cases, the user may or may not be able to disable automatic notifications, such as a found pet notification.

It will thus be understood that the method 300 may include, at least in part, scanning a tag to retrieve a unique identifier, transmitting the unique identifier over a data network to a remote computing resource, retrieving, by the remote computing resource, the animal profile associated with the unique identifier, and displaying, via a user interface, at least a portion of one or more of the animal profile and the guardian profile.

It will be understood that the method 300 described above, or any of the methods described herein, may be implemented as a computer program product. That is, in an aspect, a computer program product for processing animal records may include computer executable code embodied in a non-transitory computer readable medium that, when executing on one or more computing devices, performs the steps of the method 300. Also or instead, the method 300 described above, or any of the methods described herein, may be implemented on a system, e.g., on a component of a system such as a remote computing resource. Thus, in an aspect, a remote computing resource coupled to a data network and hosting a user interface configured for a display of a user device—e.g., where the user interface is accessible by the user device through the data network—may include a processor and a memory, the memory storing code executable by the processor to perform the steps of the method 300.

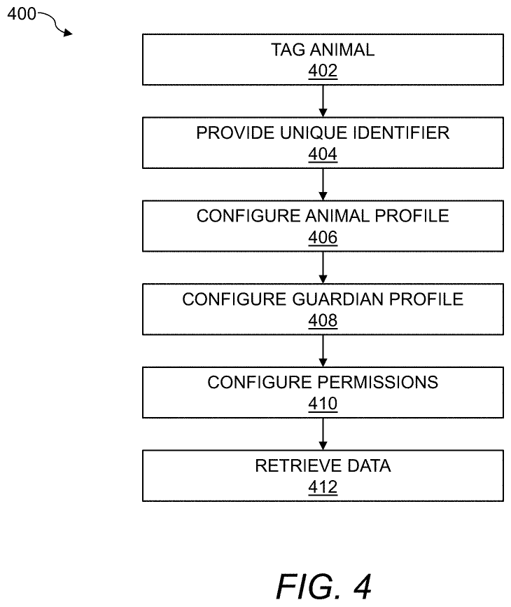

FIG. 4 is a flow chart of a method for a guardian of an animal to provide access to animal records, in accordance with a representative embodiment. It will be understood that, similar to the method 300 described above and any other methods described herein, that the method 400 of FIG. 4 may be implemented on a platform such as one supported by any of the systems described herein, such as the system 100 of FIG. 1. Further, it will be understood that many of the steps and features described herein with reference to other figures or embodiments—e.g., many of the features of the method 300 of FIG. 3—may also or instead be included in a method 400 described below.

As shown in step 402, the method 400 may include tagging an animal. Tagging the animal may include initiating tagging of the animal—e.g., a guardian may give permission for an animal to be tagged while not physically performing the tagging themselves.

As shown in step 404, the method 400 may include providing a unique identifier, which may be any as described herein. The tag may be scannable, e.g., by a tag sensor, to retrieve the unique identifier. The unique identifier may be transmitted over a data network to a remote computing resource.

As shown in step 406, the method 400 may include configuring an animal profile, which may be any of the animal profiles as described herein. Configuring the animal profile may include associating the animal profile with the unique identifier.

As shown in step 408, the method 400 may include configuring a guardian profile, which may be any of the guardian profiles as described herein. The guardian profile may include at least contact information associated with a guardian of the animal.

As shown in step 410, the method 400 may include configuring permissions. Configuring permissions may include configuring a permission status related to access of at least one of the animal profile and the guardian profile via a user interface hosted by the remote computing resource. The permissions for interaction with the animal profile may be editable in the user interface by either the guardian, the first user, or both. Similarly, the permissions for interaction with the guardian profile may be editable in the user interface by either the guardian, the first user, or both. In some embodiments, the permissions for one or more of the first user, the second user, and the third user as described herein may be customizable by the guardian in the user interface. In other embodiments, the permissions for either the second user, the third user, or both are customizable in the user interface by either the guardian, the first user, or both.

As shown in step 412, the method 400 may include retrieving data. Data may be retrieved via the user interface according to the permission status of the accessing user. Retrieved data may include at least a portion of either the animal profile, the guardian profile, or both. Permission statuses may include any as described herein, including without limitation: first permissions for a first user associated with the guardian profile, the first permissions including an ability to edit the guardian profile and at least a portion of the animal profile and an ability to view all of the animal-specific information in the animal profile; second permissions for a second user, the second permissions including an ability to view all of the animal profile and an ability to edit at least a portion of the animal-specific information in the animal profile; and third permissions for a third user, the third permissions including an ability to view at least a portion of the animal profile, and a prohibition from viewing at least a portion of the guardian profile.

It will be understood that the method 400 described above, or any of the methods described herein, may be implemented as a computer program product. That is, in an aspect, a computer program product for a guardian of an animal to provide access to animal records for the animal may include computer executable code embodied in a non-transitory computer readable medium that, when executing on one or more computing devices, performs the steps of the method 400. Also or instead, the method 400 described above, or any of the methods described herein, may be implemented on a system, e.g., on a component of a system such as a remote computing resource. Thus, in an aspect, a remote computing resource coupled to a data network and hosting a user interface configured for a display of a user device—e.g., where the user interface is accessible by the user device through the data network—may include a processor and a memory, the memory storing code executable by the processor to perform the steps of the method 400.

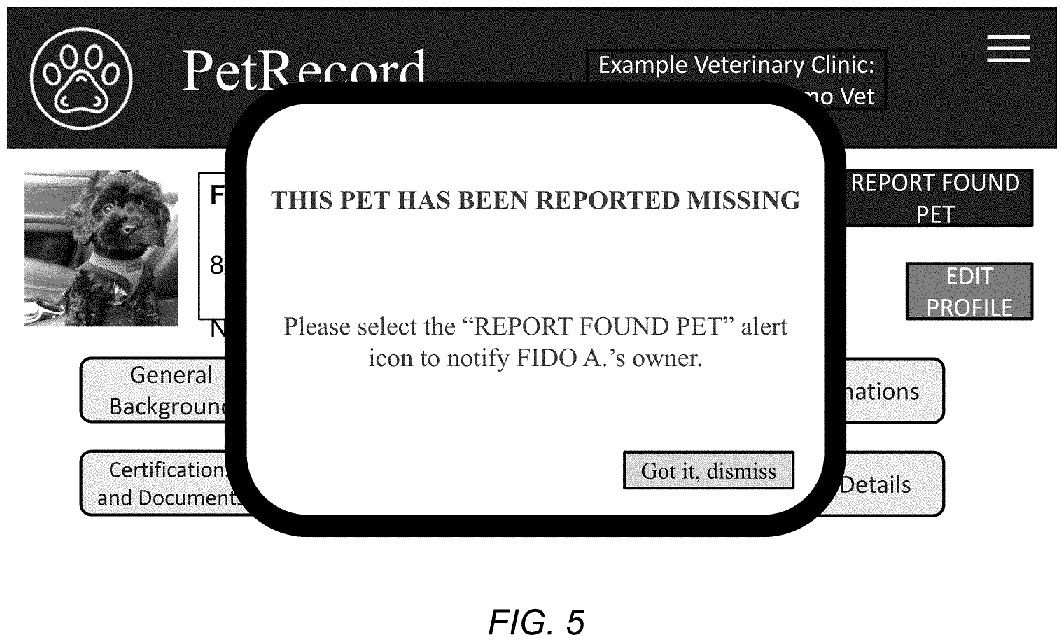

Some example embodiments and example features of a user interface will now be presented with reference to FIGS. 5-14. FIG. 5 shows a user interface including a missing pet indicator, in accordance with a representative embodiment. The user interface may be displayed on a user device such as any of those described herein. The missing pet indicator is shown as large message box or pop-up window. The missing pet indicator may automatically appear on a user interface if a pet has been reported missing in an implementation of the present teachings. The missing pet indicator may prompt a user to report a found pet, or may provide information regarding how to report a found pet. The missing pet indicator may require user interaction prior to being dismissed.

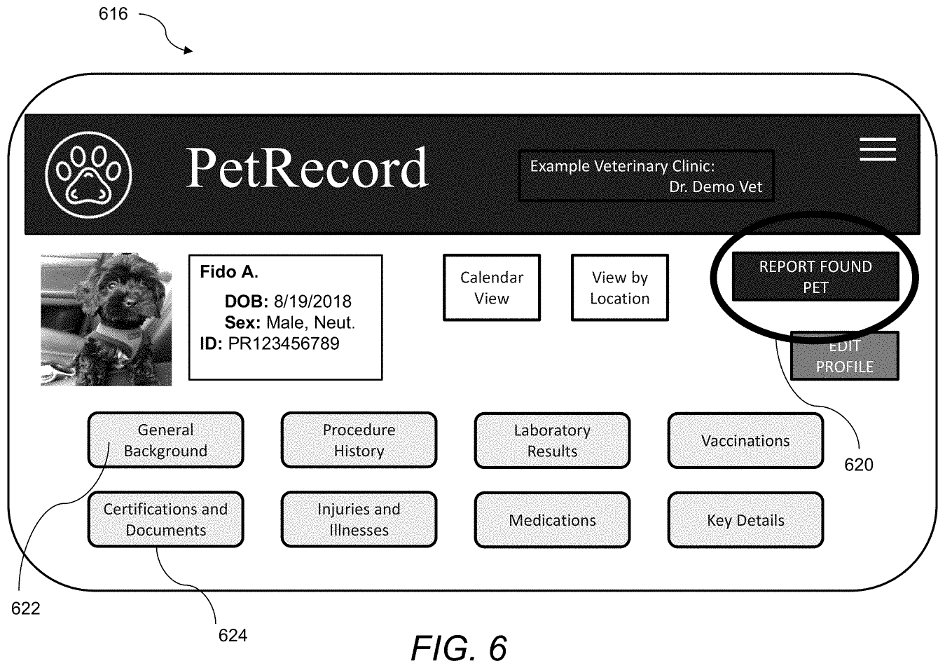

FIG. 6 shows an interactive screen of a user interface, in accordance with a representative embodiment. The user interface 616 may be what is displayed on a user device when accessing a platform according to the present teachings, or what is displayed on a user device after acknowledging a missing pet indicator such as the one described above with reference to FIG. 5. The user interface 616 may include one or more buttons that allow a user to activate a notification, such as button 620 labeled “Report Found Pet,” where selection of which may start a sequence of operations where a notification is sent to a user of the platform such as an owner of a pet. As discussed herein, some content portions may be editable by a first user as described herein, such as portion 622 labeled “General Background.” Other portions may be editable by the second user as described herein, such as portion 624 “Certifications and Documents.” In some embodiments, portions which the accessing user does not have permission to view may be shown in gray or may otherwise be similarly marked.

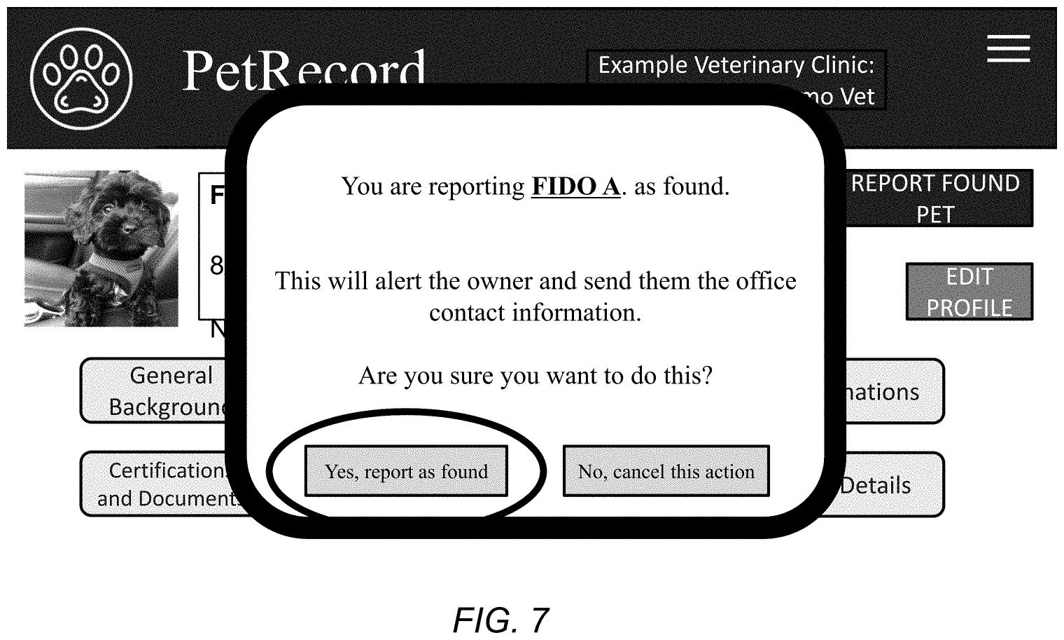

FIG. 7 shows a user interface including an alert dialog, in accordance with a representative embodiment. This is an example of a dialog that may be displayed when a user activates the “Report Found Pet” button on a user interface such as that shown in FIG. 6.

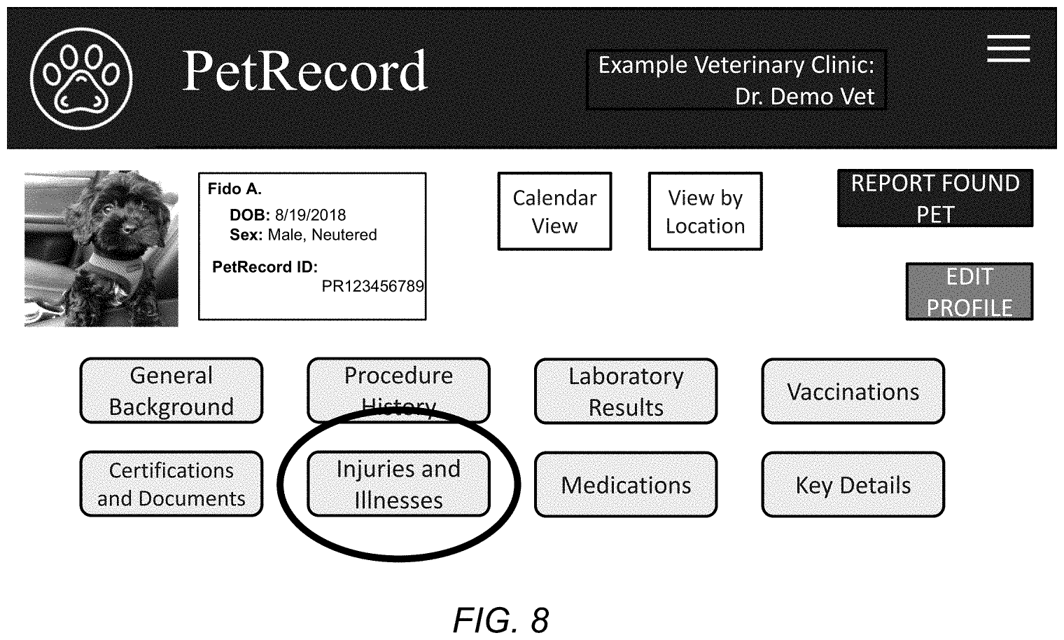

FIG. 8 shows another interactive screen of a user interface, in accordance with a representative embodiment. On this example screen, the user may select the injuries and illnesses button, which may provide access to detailed information regarding one or more injuries or illnesses for the animal, which in this example is called “Fido A.”

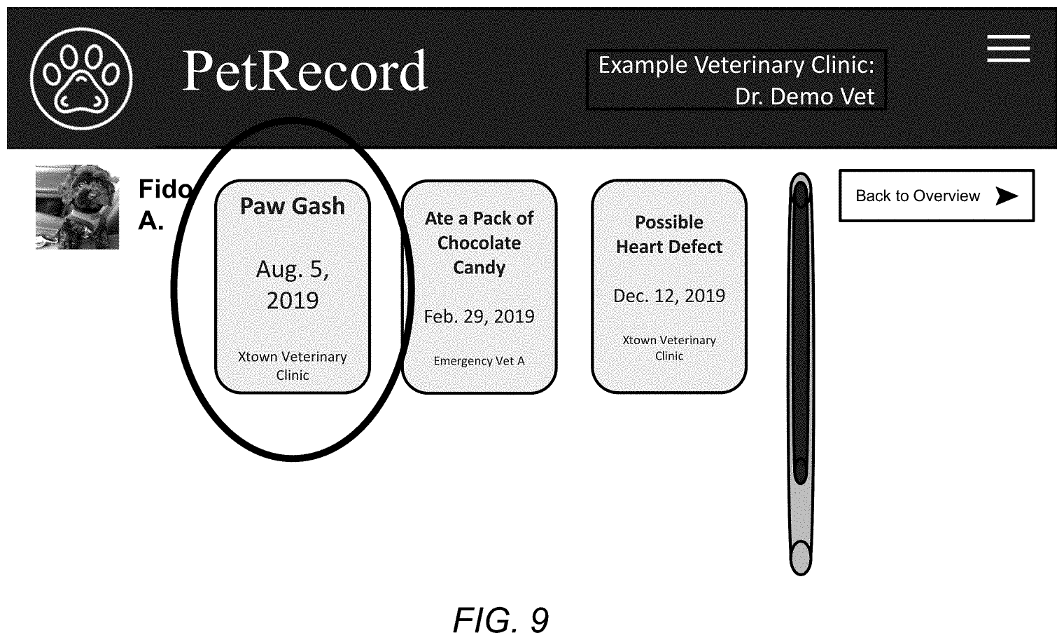

FIG. 9 shows a user interface including medical records, in accordance with a representative embodiment. The medical records may include detailed information for several incidents, which in this example include: a paw gash, eating a chocolate candy, and a possible heart defect. The user may select any of the incidents to access additional details.

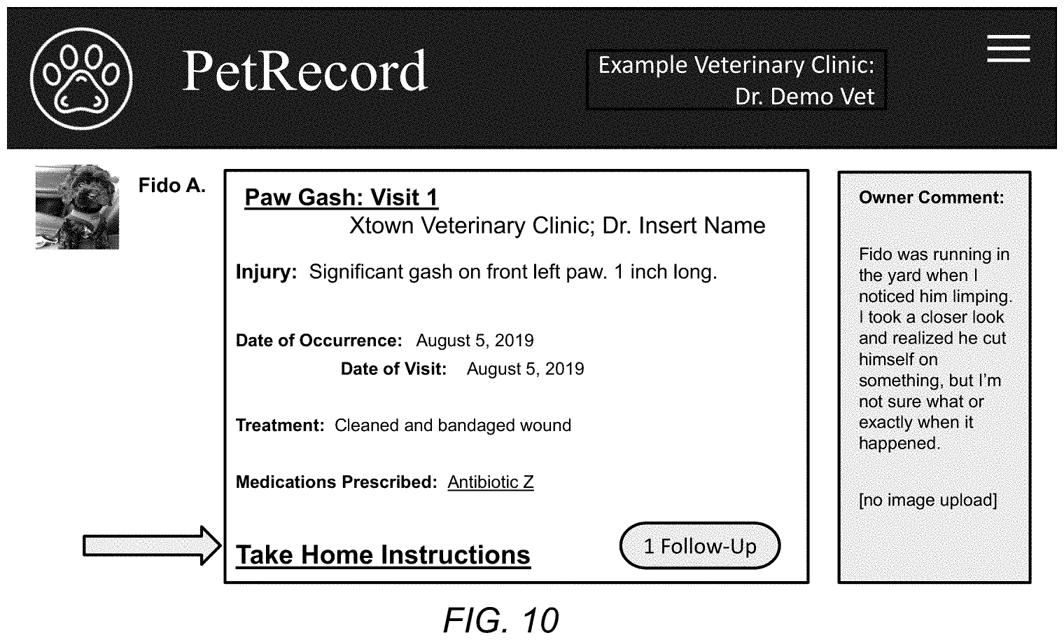

FIG. 10 shows a user interface including an incident summary for the paw gash incident, in accordance with a representative embodiment. A first user as described herein may read the incident report, edit a comment field, and proceed to view take-home instructions. A second user as described herein may have permission to edit the incident report, provide take-home instructions, and view the comments. A third user as described herein may be able to view some, all, or none of this information, depending on a permission status or rule.

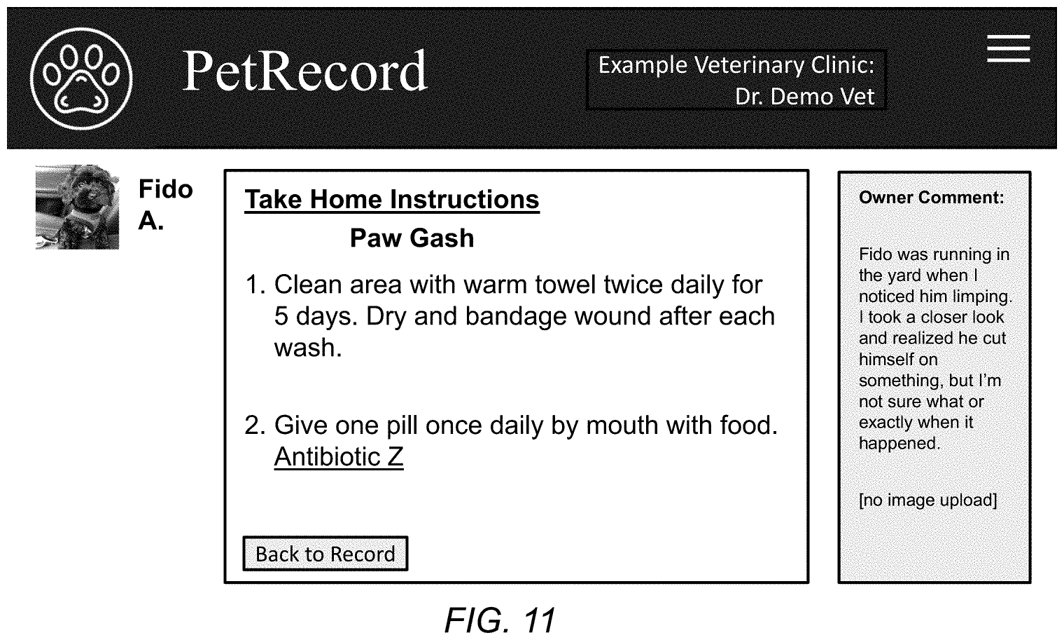

FIG. 11 shows a user interface including instructions for a guardian, in accordance with a representative embodiment. A first user as described herein may have permission to read the incident report and edit the comment field. The instructions and/or comments may also be viewable to or editable by the second user or the third user as described herein, depending on a permission status or rule.

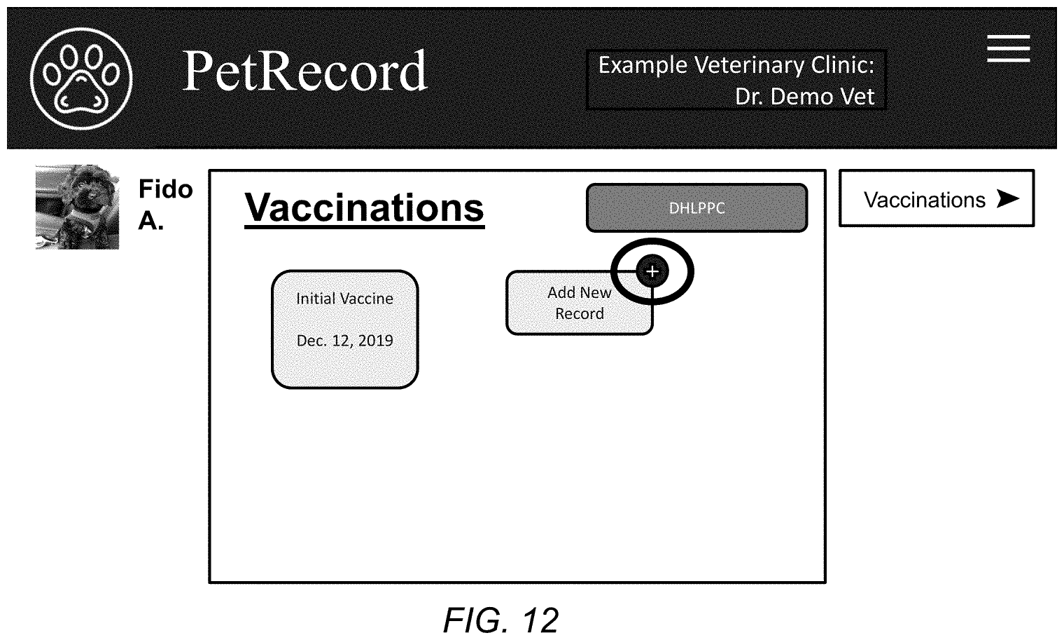

FIG. 12 shows an interactive screen of a user interface for vaccination records, in accordance with a representative embodiment. This screen may be accessed by selecting the vaccinations button on the animal profile screen of FIG. 8, for example. A user having permission to edit vaccination records, such as a second user as described herein, may add a new vaccination record.

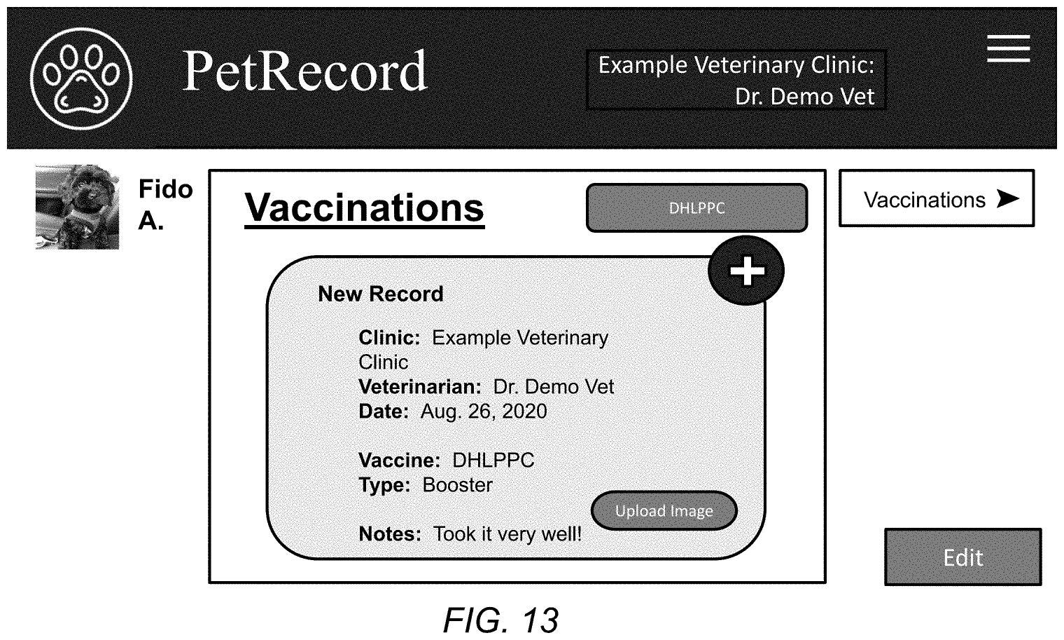

FIG. 13 shows a user interface including a detailed vaccination record, in accordance with a representative embodiment.

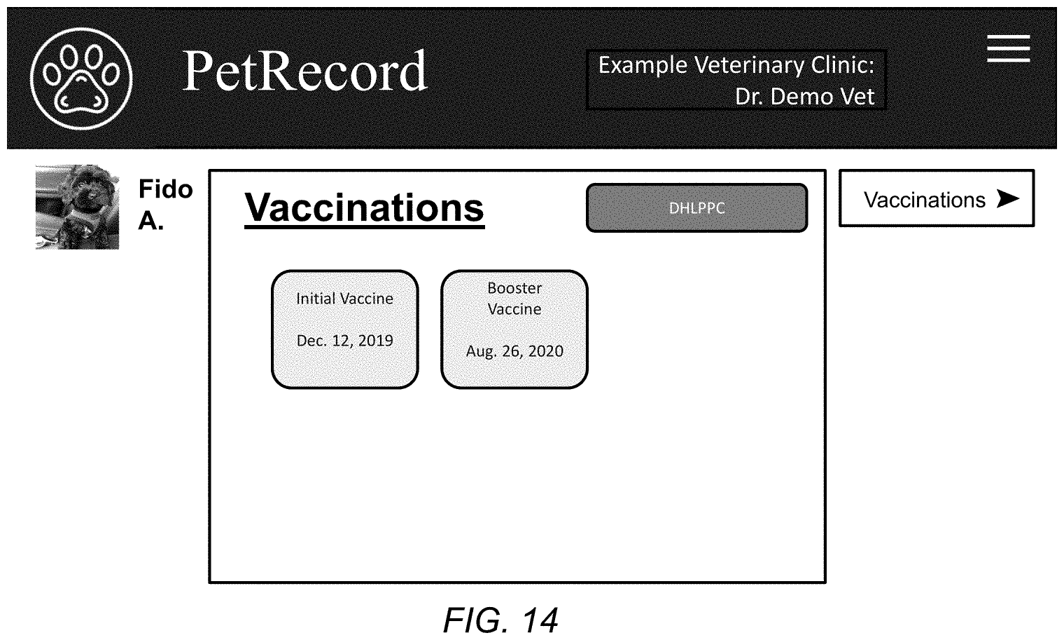

FIG. 14 shows another user interface for vaccination records, in accordance with a representative embodiment. After adding the booster vaccine in the screen of FIG. 13, the shown screen may include the updated records (evident when compared to the screen of FIG. 12).

Some example sequence of operations for using a platform featuring the present teachings will now be described.

An example of an animal shelter using a platform featuring the present teachings for a new or unknown pet will now be described. In this example, an animal control officer brings in a new dog found on the street. The dog does not have any collar or tags. An animal shelter employee scans the dog with an RFID scanner, but no signal is detected. The animal shelter employee will unwrap one presterilized injector that is preloaded with one tag according to the present teachings. The employee will then inject the tag into the loose skin on the animal's neck in between the dog's shoulder blades. They will then log into a shelter account on a platform according to the present teachings, scan the dog's new tag using the RFID scanner, and create a profile for the pet which classifies the pet as being owned by the shelter. This account can be transferred if an owner is identified. The animal shelter employees can then fill out the profile and continue with any necessary treatments, recording it as it occurs to the dog's account on the platform according to the present teachings. This can be done by scanning in documents or uploading images of the files. They can then click “Save File” to ensure all new changes are saved to the dog's profile.

An example of an animal shelter using a platform featuring the present teachings for searching for a current shelter pet will now be described. Stated otherwise, an example process for when an animal shelter employee needs to access the profile of a pet under the animal shelter's care will now be described. In this example, an animal shelter employee needs to find the profile of a cat named “Fluffy” that was brought into the shelter on Aug. 23, 2020 and is still living under the shelter's care. The employee can log onto the shelter's account on a platform according to the present teachings and select the “View Pets” tab. They can then search for Fluffy's profile by entering Fluffy's name or in-take date (i.e., Aug. 23, 2020). Depending on what the employee searches, the system according to the present teachings will either pull all profiles from animals named Fluffy or animals that were brought in on Aug. 23, 2020. Let's say that the employee searched the name “Fluffy” and multiple accounts appeared since the shelter has multiple animals named Fluffy. The employee can select filters including animal type, breed, and age to reach the correct Fluffy. Once the correct profile has been identified, the employee can click on that profile to access the profile.

An example of an animal shelter using a platform featuring the present teachings for reporting a pet as found will now be described. In this example, a stray dog is brought into “Example Animal Shelter.” The dog is scanned with an RFID scanner and is found to be chipped with a tag according to the present teachings. An animal shelter employee can log onto the shelter's account according to the present teachings, enter the dog's unique identifier, and select the “Report Found Pet” icon. This will send an alert to the dog's owner that the dog has been found and that it is located at Example Animal Shelter. In the meantime, the shelter employees may have full access to the dog's profile, allowing them to access the most current information and upload any new information pertaining to procedures done at Example Animal Shelter.

An example of a veterinary practice using a platform featuring the present teachings for when a known patient is brought into a veterinary clinic will now be described. In this example, a dog named “Fido” is brought in to see his regular general veterinarian. Since they have seen Fido before, the veterinarian knows Fido is chipped with a tag according to the present teachings. The veterinarian can scan Fido with an RFID scanner to obtain his unique identifier according to the present teachings. The doctor can then log into their veterinary practice account on a platform according to the present teachings and enter Fido's code into the search bar. From there, they can see all of Fido's information, perform any needed procedures, and upload it to his account according to the present teachings.

An example of a veterinary practice using a platform featuring the present teachings for when an unknown or new patient is brought into a veterinary clinic will now be described. In this example, a woman found a cat that she believes is a stray wandering outside her house. She brings the cat in to see her local general veterinarian. The veterinarian first scans the cat and realizes that the cat does in fact does have a tag according to the present teachings. The doctor will log onto their veterinary account, enter the cat's unique identifier found with the RFID scanner into the search bar, and access the cat's profile in a platform according to the present teachings. They can then report the cat as found and continue with the cat's check-up, uploading information as needed during the process.

In the same clinic of the above example, a man brings in a puppy he found on the side of the road. The veterinarian scans the puppy with an RFID scanner, but does not find a tag according to the present teachings. The doctor will chip the puppy with a tag according to the present teachings and contact the local animal shelter to see if anyone has reported a puppy of this kind as missing. The shelter says they have not received any word about that puppy, so the veterinarian asks the man if he would like to keep the puppy, for now or permanently. The man says no, so the veterinarian creates the puppy's profile and uses their personal owner account to link with the puppy's profile on a platform according to the present teachings. The veterinarian can then perform any necessary procedures and upload the information to the puppy's profile. Later that day, if the veterinarian does not want to foster the puppy, they can take the puppy to the nearest animal shelter and transfer ownership of the puppy from their personal account to the shelter until it is adopted to a permanent owner.

An example of a veterinary practice using a platform featuring the present teachings for when a veterinarian reports a pet as found will now be described. In this example, a cat is brought into “Demo Animal Hospital.” The cat is scanned with an RFID scanner and is found to be chipped according to the present teachings. A veterinarian can log onto their veterinary account on a platform according to the present teachings, enter the cat's unique identifier, and select the “Report Found Pet” icon. This will send an alert to the cat's owner that the cat has been found and is located at Demo Animal Hospital. In the meantime, the veterinarians may have full access to the cat's profile according to the present teachings, allowing them to access the most current information and upload any new information pertaining to procedures done at Demo Animal Hospital.

An example of an owner using a platform featuring the present teachings for when one owner account is linked to another owner account will now be described. In this example, Owner 1 is trying to link their owner account on a platform according to the present teachings to Owner 2's owner account. Owner 2 may log onto their owner account, go under the “Settings” tab, and send Owner 1 their identifying information such as the unique identifier according to the present teachings. Once this is done, Owner 1 can go onto their owner account and select Fido's profile. Then they can select the “General” tab and select “Link.” Owner 1 can enter Owner 2's identifying information into the space provided. This will send a request to Owner 2 to accept the link request. Once the request is accepted by Owner 2, the owner accounts will be automatically linked. This means that when either owner log onto their owner account, they will both be able to see all of their pets in addition to the other's pets under their “My Pets” tab. For example, if Owner 1 has a dog named Fido and Owner 2 has a cat named Fluffy, both Owner 1 and Owner 2 will be able to view, comment, and edit on both Fido's and Fluffy's profiles. Both accounts may also receive notifications if either of the pet's profiles are edited or if either of them is reported missing.

An example of an owner using a platform featuring the present teachings for when one owner account is being unlinked from another owner account will now be described. In this example, Owner 1 is trying to unlink their owner account on a platform according to the present teachings to Owner 2's owner account. Owner 2 may log onto their owner account, go under the “Settings” tab, and send Owner 1 their identifying information such as the unique identifier. Once this is done, Owner 1 can go onto their owner account and select Fido's profile. Then they can select the “General” tab and select “Unlink.” Owner 1 can enter Owner 2's identifying information into the space provided. This may send a request to Owner 2 to accept the unlink request. Once the request is accepted by Owner 2, the owner accounts will be automatically unlinked. This means that when either owner log onto their owner account, they may only be able to see all of their pets that they owned before the accounts were linked or added to their accounts. For example, if Owner 1 had a dog named Fido and Owner 2 had a cat named Fluffy before their accounts were linked, then once the owner accounts unlink, Owner 1 will only be able to access Fido's profile and Owner 2 will only be able to access Fluffy's profile. All comments or edits made by one owner on the other owner's pet's account may appear as being made by “P Owner.” For example, if Owner 2 left a comment on Fido's profile, the comment may appear as: “P. Owner made the following comment”. Additionally, if Fido is reported missing, Owner 2 may not be alerted.

An example of an owner using a platform featuring the present teachings for when one owner account is linked to a specific pet profile on another owner account will now be described. In this example, Owner 1 is trying to link the profile of their cat, Fluffy, to Owner 2's owner account on a platform according to the present teachings. Owner 2 may log onto their owner account, go under the “Settings” tab, and send Owner 1 their unique identifier. Once this is done, Owner 1 can go onto their owner account and select Fluffy's profile. Then they can select the “General” tab and select “Link an Owner.” Owner 1 can enter Owner 2's identifier into the space provided. This will send a request to Owner 2 to accept the link request. Once the request is accepted, Owner 2 will be able to view, edit, and comment on Fido's profile in addition to receiving notifications when Fido's profile is edited or when he is reported as missing. Let's say that Owner 1 also has a cat named Fluffy. Owner 2 will not be able to view, edit, or comment on Fluffy's profile—only Fido's.

An example of an owner using a platform featuring the present teachings for when one owner account is unlinked from a specific pet profile on another owner account will now be described. In this example, Owner 1 is trying to unlink the profile of their dog, Fido, from Owner 2's owner account on a platform according to the present teachings. Owner 2 may log onto their owner account, go under the “Settings” tab, and send Owner 1 their unique identifier. Once this is done, Owner 1 can go onto their owner account and select Fido's profile. Then they can select the “General” tab and select “Unlink an Owner.” Owner 1 can enter Owner 2's identifier into the space provided. This may send a request to Owner 2 to accept the unlink request. Once the request is accepted, Owner 2 may no longer be able to view, edit, and comment on Fido's profile or receive notifications regarding when Fido's profile is edited or when he is reported as missing.

An example of an owner using a platform featuring the present teachings for reporting a pet missing will now be described. In this example, an owner realizes their dog, Fido, is missing. The owner can log onto their owner account on a platform according to the present teachings, select Fido's profile, and select the “Report Missing” icon. This will flag Fido's account so that any time that an animal shelter employee or veterinarian accesses Fido's profile, a notification will alert them of Fido's status as missing. A notification may also or instead be sent to the owner.

An example process for when ownership of an animal will be transferred from one owner account to another owner account using a platform featuring the present teachings will now be described. In this example, Owner 1 wants to transfer ownership of their dog, Fido, to Owner 2 on a platform according to the present teachings. Owner 2 may log onto their owner account, go under the “Settings” tab, and send Owner 1 their unique identifier. Once this is done, Owner 1 can go onto their owner account and select Fido's profile. Then they can select the “General” tab and select “Transfer Ownership.” After completing a series of questions to ensure the legitimacy of the request, Owner 1 can enter Owner 2's identifier into the space provided. This will send a request to Owner 2 to accept ownership of Fido. Once the request is accepted by Owner 2, Fido's profile will no longer appear on Owner 1's “My Pets” tab and will appear under Owner 2's “My Pets” tab.

An example process for when ownership of an animal will be transferred from an owner account to an animal shelter account using a platform featuring the present teachings will now be described. In this example, a pet owner wants to surrender their cat, Fluffy, to an animal shelter. After taking Fluffy to the shelter, the owner can go onto their owner account on a platform according to the present teachings, select Fluffy's profile, go under the “General” tab, and select the “Transfer Ownership” icon. After completing a series of questions to ensure the legitimacy of the request, the owner can search for the name of the shelter that they are surrendering Fluffy to. After selecting the shelter, a notification may be sent to the animal shelter's account to accept the request to accept ownership of Fluffy. Once an animal shelter employee accepts the request, Fluffy's profile will no longer appear in the owner's “My Pets” tab and will appear in the list of pets under the animal shelter's care on their account.

An example process for when ownership of an animal will be transferred from an animal shelter account to an owner account using a platform featuring the present teachings will now be described. In this example, a pet owner adopts a dog named Fido from a participating animal shelter that uses a platform according to the present teachings. An animal shelter gives the owner Fido's unique identifier. The owner can log onto their owner account on a platform according to the present teachings, select the “Add a Pet” Icon, and enter Fido's identifier into the space provided. This may send a request for approval to the animal shelter, and once the ownership transfer is approved, the owner may receive a notification stating that the transfer of ownership was successful. The owner can now see all of Fido's information.

Some of the advantages of the present teachings, as well as some additional features of the present teachings will now be described. As discussed herein, the present teachings may include a tag featuring a chip that can be scanned to reveal an animal's identification code, where this code can be searched on a platform as described herein (e.g., via a website) to reveal all known information on the animal at any time.

Three benefits of the present teachings can include saving time, increasing safety and security, and providing peace of mind—each of these is addressed below.

The present teachings may save time. A 2020 study by the Journal of the American Medical Informatics Association (JAMIA) found that veterinary medical records are only stored by individual veterinary practices; in order to access this information, an office employee must fax or email the documents. However, the present teachings may permit doctors to use the preferred virtual format in a way that is accessible to other offices. Because the files may be able to be accessed and edited at any time, there may be no need to call other offices to obtain records. This can save time for a practice needing information as well as a practice that would have otherwise needed to gather and send the files.

Using existing techniques, by way of example, when a lost, microchipped pet is brought into a shelter, the shelter must first call the microchip company to obtain the owner's information and then call the owners to receive their veterinarian's contact. After that, they can call that office and request records to be sent over. Veterinarians go through this same lengthy process for unknown animals in similar situations, which can take as long as 30 minutes. However, the present teachings can eliminate the need for the aforementioned inefficient process entirely since all one may have to do is scan and search the identification code on a website or platform.

Additionally, reuniting lost pets with their owners can be a lengthy process with a traditional, existing microchip system. However, the present teachings, as explained herein, may include a “FOUND PET” icon on each pet account that can be selected by veterinarians and shelters to send a text to the number of the owner's account. This can save an organization from making a series of calls to reunite pets with their owners and can notify the owner once the icon is selected.

The present teachings may increase safety and security. Pet safety is the cornerstone of the veterinary and animal shelter fields. Giving doctors access to all of a pet's information nearly instantly can help to save its life in emergency situations or prevent the pet from undergoing unnecessary treatments, such as double vaccinations, where in some instances, vaccinating an animal twice can result in allergic reactions, changes in behavior, or autoimmune diseases due to overloading the pet's bodily defense systems.

Further, using the present teachings, an owner's private information may be secure. While the standard lost pet-owner reuniting microchip system involves giving out the owner's name and phone number to any animal care organization that calls the microchip company with an identification code, the reuniting process of the present teachings may instead use the owner's platform account to notify them that their pet has been found. Thus, the present teachings may not require that the owner's name, phone number, or address be distributed. The present teachings may send a text notification to the phone number attached to the owner profile with a message alerting them that their pet has been found and where. An example of such a text (or similar) notification includes: “Your pet, [name], has been found by [name of veterinarian or animal shelter that clicked the alert button] at [office address]. Please call [office phone number] to bring your pet home!”

The present teachings may also include a document blur capability that automatically blurs specific sensitive information (such as names, addresses, and other private information) on one or more documents or files. This features may allow a large set of documents to be uploaded to an animal's account and can simplify the ownership transfer of pets. Using this feature, the system may be able to better protect the identities of past owners while including a large number of documents.

The present teachings may also include sending text messages to a connected owner account every time their pet's profile is edited. This may be done to ensure that if a pet is stolen, the pet's owner will be able to notify the veterinarian or shelter their pet is brought to. These notification settings can be managed through a website or the like featured in a platform implementing the present teachings. An example of such a text (or similar) notification includes: “The profile of your pet, [name], has been edited by [name of veterinarian or animal shelter that has uploaded information] at [office address]. Please call [office phone number] for additional details.” A “MISSING PET” tag can also or instead be added to a pet's profile if owners notice their pet is either lost or stolen. This notification may appear highlighted on a pet profile for any veterinarian or shelter that looks at the profile. Notifications may also include reminders to pet owners for a variety of items such as appointments, medication refills, vaccine boosters, etc. Such notifications will make it easier for pet owners to manage their pets and their needs.

The present teachings may provide peace of mind. Many veterinary technicians experience an animal-related injury at some point in their careers, and knowing whether the pet is vaccinated can comfort employees in these situations since they can be sure the pet doesn't have certain major diseases that are transmissible to humans. Owners may also benefit from knowing that if their pet is separated from them, a notification will be sent when their profile is accessed and any information that doctors and shelters need to effectively care for them may be readily available until they can be reunited. Additionally, if the pet has an emergency, time will not be wasted getting information, increasing the pet's chances for survival and recovery.

The present teachings may benefit animal shelters. Currently, most animals that shelters see have no medical history that is viewable to the shelter. The present teachings may thus provide quick access to information on any chipped animals they see, which will allow the staff to adjust accordingly to ensure their safety while handling an animal. Shelters may examine, vaccinate, deworm, and flea-treat animals with no history as a precaution, which can result in pets being given excess medications. This practice can waste a significant amount of money, but is necessary to protect the staff. However, using the present teachings, this practice may not be necessary, and thus could represent significant cost saving since shelters will no longer need to spend money on potential double vaccinations.

The present teachings may benefit veterinary offices. Using existing systems, virtual files cannot often be accessed by different practices. On the other hand, the present teachings may cater to the modern system of virtual files while making the information accessible to other organizations. Veterinarians may also benefit from the same safety, time-saving, and long-term cost-reducing benefits as animal shelters.

The present teachings may be useful for pet boarding and grooming facilities. Proof of vaccinations is a common requirement of both grooming and boarding facilities as per state laws. Other times, different organizations can require their own specific set of vaccinations in order to be seen. Thus, the present teachings may provide a record-keeping service that enables employees in these fields to view vaccine history, which may otherwise be unavailable without the present teachings.

The present teachings may be useful for pet owners. In particular, the present teachings can benefit an owner that cares strongly about being prepared for when their pet has an emergency situation.

The present teachings may provide advantages over existing pet chipping and pet record systems because the present teachings may not require a specific type of tag/chip, or a specific type of tag reader, for an animal in order to function in an intended manner. That is, the present teachings may improve upon existing systems by being accessible by every scanner on the market as opposed to requiring every office to have a specific scanner which must connect to a computer. Additionally, using other existing systems, a pet's account may only be accessed if the pet is scanned immediately prior to the look up or if it is a patient of the clinic. This means that for veterinarians who work at different clinics on certain days of the week, they can only access their patients' accounts at the practice in which they see the patient. This can increase the chance that items that come in after the pet has visited, such as bloodwork, will be forgotten to be uploaded. Additionally, if a pet from one practice has an issue while a veterinarian is working at another practice, there may be no way for the doctor to view the information on that patient's account. Using the features described herein, these issues may be solved or alleviated.

Moreover, often when using existing chip systems, the same company that owns the animal's microchip must be contacted in order to gain the owner's information. This can create an array of issues, from companies that have gone out of business to pets that have chips but are not registered with the company database. Additionally, when customer service of the companies is slow it can take a relatively long time to receive any information. For example, it is common for shelters to use free or low-cost microchips in order to save money, but they truly pay for it by the inconvenience and lack of service they experience. Also, the database of existing systems may only be able to contain simple pieces of information due to release laws. This can prevent the look-ups from being accessible to those other than the microchip company and can limit what information can be stored. These limitations can come together to restrict what the microchip system is able to provide. Using the features described herein, these issues may be solved or alleviated.

Chat Feature

A chat feature may be included that allows for animal shelter accounts, veterinary accounts, and pet industry accounts to directly message owner accounts through their pet's profile. These messages may function similarly to messaging an anonymous profile.

In order to access the chat, a veterinarian or animal shelter employee may access an animal's profile and select a chat icon. This may pull up a new message box where they can send a message that goes directly to the pet's owner.

The owner may receive a notification similar to: “[Animal shelter/Veterinary practice name] has sent a chat regarding [Pet's name].” The owner can then access the chat through their owner profile and respond by selecting the message and sending a message in a format similar to a standard text messaging system. The owner's response may appear under the notifications section of the animal shelter or veterinarians' profile. They may thus enter this tab, select the message, and respond if they so choose.

Checkout Abilities

Checkout abilities may enable owners to pay veterinarians, animal shelters, and pet industry professionals via their account. This can make it more convenient for veterinarians and pet industry professionals to bill out their customers and for pet owners to adopt pets from animal shelters and pay their adoption fees. These abilities may also be added for farm and breeder accounts so that they will not only be able to pay others for other services, but receive funds for animals they sell.

Service Search

A service search feature may allow owner accounts to search for specific services, such as veterinary, boarding, and grooming services. This may allow owners to find veterinarians, animal shelters, and pet industry professionals who are a part of the community of users.

Finding Pets New Homes

A feature can be included that allows animal shelters and breeders to “post” the profiles of animals that are up for foster or adoption. These profiles can be viewed by owners who are looking to foster or adopt new pets. The owner accounts may be able to view the background, vaccine, and injury and illness tabs of those animals, and they may be able to use a modified version of the chat feature to message the breeders or rescues regarding those pets.

Pedigree Print

A Pedigree Print feature may be primarily used by farm and breeder accounts to trace, record, and show proof of their animals' bloodlines. However, any pet can be added to a Pedigree Print database to show proof of the pet's genetic background. This feature may vary from a simple chart of sires and dames to a diagram that includes information regarding inherited disorders, club and program recognitions (such as AKC registrations), and other details that may pertain to future offspring.

Medical Manager

A medical manager feature may make it easier for pet owners to keep track of their pet's medications. This may create a check list of an owner's pets and the medications they need to take each day to help pet owners make sure that they give each of their pets the medications they need. For example, if you have one pet that needs to take one capsule once a day for a week and another pet that needs to take ½ a tablet twice a day for two days, the medical manager may create a checklist similar to the one below:

DAILY MEDICATIONS

| | |
|---|---|
| 10/16 . . . Morning | Pet 1: |
| | □ 1 [Pill Medication Name] |
| | Pet 2: |
| | □ ½ [Tablet Medication Name] |
| 10/16 . . . Evening | Pet 2: |
| | □ ½ [Tablet Medication Name] |
| 10/17 . . . Morning | Pet 1: |
| | □ 1 [Pill Medication Name] |
| | Pet 2: |
| | ½ [Tablet Medication Name] |

[This list will continue until both medications are no longer needed]

### Example Checklist of Medical Manager

These boxes can be checked off so owners can be sure that each pet received the medications that they need. If medication refills are needed, the medical manager may send a notification to the owner instructing them to contact the veterinarian who originally prescribed the pet's medication for a refill. For example, if Pet 2 needs a refill, the medical manager may send the owner a notification saying, “Pet 2 needs a refill of [Tablet Medication Name]. Please contact [Vet who prescribed the medication] for a renewed prescription.”

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionalities may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

It will be appreciated that the devices, systems, and methods described above are set forth by way of example and not of limitation. For example, regarding the methods provided above, absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

what is claimed is:

1. A method for processing animal records, the method comprising:
receiving, over a data network by a remote computing resource, a unique identifier associated with a tag, the tag scannable via a tag sensor to retrieve the unique identifier;
creating, by the remote computing resource, an animal profile associated with the unique identifier;
associating the animal profile with a guardian profile, the guardian profile including at least contact information for a guardian associated with an animal included in the animal profile;
storing animal-specific information for the animal in the animal profile, the animal-specific information including at least one of a vaccination record, a medical procedure record, a current treatment, health history, a certification, a dietary restriction, animal breed information, and genetic information; and
providing a user interface for accessing at least a portion of one or more of the animal profile and the guardian profile from the remote computing resource over the data network, wherein information within the user interface is configured for access by each of:
a first user associated with the guardian profile, the first user having permission to edit the guardian profile and at least a portion of the animal profile and permission to view all of the animal-specific information in the animal profile;
a second user, the second user having permission to view all of the animal profile and permission to edit at least a portion of the animal-specific information in the animal profile; and
a third user, the third user having permission to view at least a portion of the animal profile, and the third user being prohibited from viewing at least a portion of the guardian profile.

2. The method of claim 1, further comprising, in response to receiving the unique identifier retrieved by scanning the tag, automatically activating a found animal indicator for the animal having the animal profile associated with the unique identifier.

3. The method of claim 2, wherein the found animal indicator is only activated when the unique identifier is received from one or more of the second user and the third user.

4. The method of claim 2, further comprising automatically transmitting a notification to one or more of the guardian and the first user upon activation of the found animal indicator.

5. The method of claim 4, wherein the notification includes contact information for a user that transmitted the unique identifier.

6. The method of claim 4, wherein the notification includes a location of a device that transmitted the unique identifier.

7. The method of claim 1, wherein the user interface includes a missing pet indicator, and wherein one or more of the first user and the guardian has permission to activate the missing pet indicator.

8. The method of claim 1, further comprising querying a database for at least one of a predetermined accreditation and a permission status of a user attempting to access information within the user interface.

9. The method of claim 8, further comprising:
determining whether the user is the first user, the second user, or the third user based on the at least one of the predetermined accreditation and the permission status; and
providing permissions for access to the information in the user interface according to the determination.

10. The method of claim 1, wherein permissions for one or more of the second user and the third user are customizable by one or more of the guardian and the first user in the user interface.

11. The method of claim 1, wherein the animal is a pet, and wherein the guardian is an owner of the animal.

12. The method of claim 1, wherein the first user is one or more of the guardian, a veterinarian of record for the animal, and an administrator for the user interface.

13. The method of claim 1, wherein the second user is one or more of a veterinarian office, an animal hospital, a government entity, and a shelter.

14. The method of claim 1, wherein a user must have a predetermined accreditation to become one or more of the first user and the second user.

15. The method of claim 1, wherein the third user is one or more of an unknown user and an unaccredited user.

16. The method of claim 1, wherein the third user is prohibited from viewing all of the guardian profile.

17. The method of claim 1, wherein the tag includes one or more of an integrated circuit, a microchip, and a nanochip.

18. The method of claim 1, wherein a portion of the unique identifier indicates compatibility with a platform including the user interface.

19. A computer program product for processing animal records, the computer program product comprising computer executable code embodied in a non-transitory computer readable medium that, when executing on one or more computing devices, performs the steps of:
receiving a unique identifier associated with a tag, the tag scannable via a tag sensor to retrieve the unique identifier;
creating an animal profile associated with the unique identifier;
associating the animal profile with a guardian profile, the guardian profile including at least contact information for a guardian associated with an animal included in the animal profile;
storing animal-specific information for the animal in the animal profile, the animal-specific information including at least one of a vaccination record, a medical procedure record, a current treatment, health history, a certification, a dietary restriction, animal breed information, and genetic information; and
providing a user interface for accessing at least a portion of one or more of the animal profile and the guardian profile, wherein information within the user interface is configured for access by each of:
a first user associated with the guardian profile, the first user having permission to edit the guardian profile and at least a portion of the animal profile and permission to view all of the animal-specific information in the animal profile;
a second user, the second user having permission to view all of the animal profile and permission to edit at least a portion of the animal-specific information in the animal profile; and
a third user, the third user having permission to view at least a portion of the animal profile, and the third user being prohibited from viewing at least a portion of the guardian profile.

20. A system for processing and storing animal records, the system comprising:
a tag scannable via a tag sensor to retrieve a unique identifier associated with the tag;
a data network;
a user device having a display, the user device coupled to the data network;
a database configured to store animal records;
a remote computing resource coupled to the data network and hosting a user interface configured for the display, the user interface accessible by the user device through the data network, the database in communication with the remote computing resource, wherein the remote computing resource includes a processor and a memory, the memory storing code executable by the processor to perform the steps of:
receiving the unique identifier over the data network;
creating an animal profile associated with the unique identifier;
associating the animal profile with a guardian profile, the guardian profile including at least contact information for a guardian associated with an animal included in the animal profile;
storing animal-specific information for the animal in the animal profile, the animal-specific information including at least one of a vaccination record, a medical procedure record, a current treatment, health history, a certification, a dietary restriction, animal breed information, and genetic information; and
controlling access to at least a portion of one or more of the animal profile and the guardian profile according to a permission status, the permission status including:
first permissions for a first user associated with the guardian profile, the first permissions including an ability to edit the guardian profile and at least a portion of the animal profile and an ability to view all of the animal-specific information in the animal profile;
second permissions for a second user, the second permissions including an ability to view all of the animal profile and an ability to edit at least a portion of the animal-specific information in the animal profile; and
third permissions for a third user, the third permissions including an ability to view at least a portion of the animal profile, and a prohibition from viewing at least a portion of the guardian profile.
